(19) United States
(12) Patent Application Publication
(10) Pub. No.: US 2010/0151107 A1
(43) Pub. Date: Jun. 17, 2010

(54) EXTRACTION METHOD FOR THE CLASSIFIED EXTRACTION AND SEPARATION OF VEGETABLE COMPONENT MATERIALS, AND THE APPLICATION THEREOF

(76) Inventor: Aslieh Nookandeh-Baumgärtner, Saarbrucken (DE)

Correspondence Address: KOLISCH HARTWELL, P.C., 200 PACIFIC BUILDING, 520 SW YAMHILL STREET, PORTLAND, OR, 97204, US

(21) Appl. No.: 12/514,794

(22) PCT Filed: Nov. 12, 2007
(86) PCT No.: PCT/EP2007/009780

§ 371 Date: Jan. 28, 2010

(30) Foreign Application Priority Data
Nov. 13, 2006 (EP) 06023573.6

(51) Int. Cl. C12C 3/08; C12C 1/02

(52) U.S. Cl. 426/592; 426/431; 426/600

(57) ABSTRACT

The present invention refers to extraction methods for classified extraction and separation of vegetal and/or animal ingredients by means of a multi step elution process. Particularly, the present invention refers to separation of vegetal ingredients, so for example for the extraction and separation of hops ingredients, using the vegetal self-cellulose as stationary phase. Furthermore, the present invention refers to the use of thus obtained hops extracts for the production of beers, enriched with and depleted of phyto-hormones, respectively, as well as beers enriched with xanthohumol.

The present invention relates to extraction methods for classified extraction and separation of vegetal and/or animal material by a multi-step elution process. In particular, the present invention relates to separation of vegetal (plant, respectively) materials, for example for extraction and separation of hops materials (ingredients, respectively) by utilising vegetal (plant, respectively) self-cellulose as stationary phase. The present invention further relates to the use of hops extracts obtained in such a way, being enriched with and depleted of phytohormone, respectively in the production of beers, as well as beers enriched with xanthohumol.

The possibility of isolation and separation of natural materials of plant (vegetal, respectively) origin is on the one side based on the different chemical structure of the compounds. On the other side the separation of natural materials is affected by the binding nature of the material to be isolated onto the vegetal material, i.e. the self cellulose. A separation and extraction of defined vegetal materials lie, for example, for the pharmaceutical and food industry within the scope of highest interest for the development of drugs and food additives.

Natural materials of vegetal or animal origin contain chemical compounds or mixtures thereof, which are of high interest, for example, for the development of drugs for the chemical and pharmaceutical research. In recent years many methods have been developed to isolate chemical compounds or mixtures of closely related compounds from natural materials and to characterise due to the different binding properties. Recently, besides conventional distillative separation methods or acid base separation steps, in particular chromatographic methods have been introduced and improved. Chromatographic methods enabling a separation of substances having high chemical similarity are, for example high performance liquid chromatography (HPLC). In this case a gel, which can contain among others silicates, cellulose, serves as a stationary phase. The strength of the binding to the stationary phase (due to different hydrophilic and lipophilic binding forces, respectively) of the molecules to be separated and the polarity of the eluent determine separability.

On the basis of the above stated principle different chromatographic methods have been described in many publications. For example are mentioned: analytical and preparative HPLC (High-Performance Liquid Chromatography; Schneider, B. et al., Phytochem. Anal. 9, 237-244 (1997); Yu Zhao et al., J. Chromatography A 837, 83-91 (1998)), solid-phase extraction (Öllers, S. et al., J. Chromatography A 911, 225-234 (2001)), LC-NMR (Liquid Chromatography-Nuclear Magnetic Resonance Spectroscopy) and the LC-MS (Liquid Chromatography-Mass Spectroscopy; Schütze, W. et al., Agroindustria 3, 399-401 (2004); Wijaya, C. H. et al., J. Agric. Food Chem. 53, 1637-1641 (2005); Ziegert, K. et al., 40. Symposium of the DGQ in Karlsruhe, 14.-15.03.2005, conference transcript 75-78 (2005); Ritzdorf. I. et al., Phytochemistry 50, 995 (1999); Effers, K. et al., Eur. J. Org. Chem. 2793 (1999); Marner, F.-J. et al., Phytochemistry 60, 301 (2001)), which enable identification, isolation, purification, and structural elucidation of materials, present in vegetal (plant, respectively) organisms to the point of analytical identification of active agents and metabolites within the scope of in vitro and in vivo experiments (Nookandeh, A. et al., Phytochemistry 65, 561-570 (2004)). Insofar, the just now mentioned chromatographic methods are adverse, since these are cost-intensive, labour, and time consuming. A continuous monitoring is necessary by qualified staff members and can only be badly automated for the performance within high precision. Additionally, material consumption is very high, since large amounts of solvent are necessary. Furthermore, by applying chromatographic methods there is the risk, that the column material (stationary phase) induces a degradation reaction in the substances to be separated and thus a substance to be separated is often eluted with low yield.

A further group of separation methods is based on electrophoresis technology. In these methods only charged particles are separated in the electric field. Capillary electrophoresis allows for example a very good separation of charged particles in smallest amounts. By applying high voltage (2-35 kV) the charged particles are separated due to their different charge and mobility in the electric field (Seidel B. S. et al., J. Biomed. Opt. 2, 326-331 (1997)).

Gel permeation chromatography (GPC) and molecular sieve chromatography utilise the different diffusion paths of molecules of different size through pores into the cavities, which occur by cross linking of the carbohydrates and form the solid elements of the gels. Large molecules are separated from small ones in that they find a smaller volume for their spatial distribution. Gel chromatography and molecular sieve chromatography rely on the same principle. The most often used dextran gels are microbiologically obtained for example from bacteria. Sephadex is an Agarose gel. The separation of polar, water soluble analytes serve hydrophilic stationary phases. Organophilic stationary phases are suited for the separation of non polar analytes, which are dissolved in organic solvents (polystyrene gel or organophilic dextran gel). Molecular sieve chromatography is mainly applied for separation of gases and fluids with low molar mass. Moreover, when using for example zeolites, this sort of chromatography serves for drying of gases and fluids or for removing of ethanol from chloroform. The advantages of these methods are the possibility to separate the molecules for size and form and to use the stationary phase repeatedly. Disadvantages result from that the most common gels sinter by applying force and that the column must be newly packed when changing the eluent, since the flow rate due to sintering or the increasing packing density is lower.

In case of paper chromatography a chromatographic separation method for small amounts of substance is concerned. In this case the filter paper serves as stationary phase and the solvent or the solvent mixture as mobile phase. A small amount of a substance mixture is in dissolved form applied onto a sheet of filter paper. After drying the filter paper is with the lower edge immersed in the solvent in such a way that the previously applied sample does not immerse in the solvent. Caused by the capillary effect of the filter paper the solvent rises slowly upwards. Thereby the substance mixture is also captured by the upwardly migrating solvent. The single substances included in the mixture show specific interactions (adsorption and desorption) with the filter paper, so that for each substance of the substance mixture a specific migration rate results in the upwardly migrating solvent. Due to this different migration rate a separation of the mixture results by and by into their single components. Paper chromatography is completed shortly before the solvent reaches the upper edge of the filter paper. If the substance mixture consisted of coloured components coloured spots, separated from another are found on the paper. The chromatographic separation of vegetal materials on the self-cellulose is very similar to the partition chromatography, i.e. paper chromatography.

With the assistance of extractive separation methods by an extraction agent specific materials or material mixtures are dissolved from their binding onto solid materials (substances, respectively). A disadvantage is, that the extracts obtained in this way often contain undesired, accompanying vegetal components such as for example lipids, chlorophylls and waxes, which hamper active agent extraction as well as in enriched with and in pure form. A further disadvantage is that such methods require a clear phase separation, which often does not occur.

In case of commonly applied extraction methods the vegetal extraction good (material, respectively) is discontinuously and continuously added with the solvent and the extraction good is separated from the vegetal material contained in the solvent after elution. This extraction process delivers more or less the total of the non separated vegetal materials in solution. In contrast to the commonly used extraction methods the use of the herein newly described method of the elution and washing-out process, respectively, is carried out stepwise with changing, defined solvents and/or solvent mixtures of different composition. The vegetal materials are according to their strength of binding on the vegetal self-cellulose successively dissolved from this specific binding and therefore from the extraction good. In case of the here described method the separation of the on the one hand desired materials can be achieved from the on the other hand the elution possibly disrupting materials by controlling the elution procedure, so that for example the disrupting materials are dissolved with a first solvent or solvent mixture and subsequently the extraction of the interesting material or materials is carried out. This process can also be carried out conversely.

With some of the above described methods the extraction of the hops materials for use in the brewage industry is carried out already since the year 1890. In the following under hops the hops and hop umbel, respectively, is understood both freshly harvested and in the commercially available condition. Furthermore hops products for example hops powder or with lupulin enriched hops powder in the form of pellets, hops pressed juice, hops extracts or hops extract powders are suited for winning of extracts for the brewage industry. Hops contains resins, oils, waxes, water soluble compounds (particularly sugar, tanning agents and proteins) and a solid-like, gel containing matrix, namely self-cellulose.

In the past time the procedure consisted knowingly therein, that the undesired components of the hops were completely removed in the scope of beer brewing, while instable components were at first isolated and in later step of the brewing procedure added again. Desired components were refined before addition to increase their stability or to change and improve beer taste, respectively. Ingredients like for example bittering agents have already been used in concentrated form. Use of the hops for the brewage economy dates from a long tradition. Yet, according to DE-PS 54 812 in the year 1890 lupulin has been extracted at first from the hop umbel/hops and has later again been added to the lupulin free umbel in desired concentration as aqueous extract. According to DE-PS 535 841 from the year 1928 oils and resins of the hops are extracted in such a way that in a closed system under vacuum in a kind of a rotary evaporator water and alcohol is directed through the hops, partly as condensate, which is however procedural very complicated and cost intensive. Not until the extraction methods developed in the beginning of the twenties with the assistance of methyl chloride resulted in an economic and technical success for that time.

For a long time ethanol as one of the most known extraction agents has not been used for different reasons, although just this substance as a product specific beer constituent would not have to be objected in brewing. Of big disadvantage was that by means of the alcohol extraction no non-bittering agents free bittering agent extract could be obtained. Until nowadays it is the object for the brewing industry to provide a standardized preparation. It is complicating that a hops extract is produced, which is extracted with ether or alcohol and than multi step wise with an alcohol/water mixture and disassembled into the constituents, to mix together the in this way obtained constituents to a new preparation in a desired composition.

A method for extracting desired components from natural hops products, with which no contaminations by residues of organic solvents occur, is the application of a super critical fluid, e.g. carbon dioxide, for extraction (DE 21 27 618 A). Further application examples of this method are found in JP 44864 B (1973), JP 41376 B (1989), U.S. Pat. No. 4,104,409 and U.S. Pat. No. 4,344,978. In all above mentioned cases the high costs and the high procedural input are adverse. The used gadgets must stand a pressure up to 400 bar at an extraction temperature of up to 100° C. Further disadvantages are the large amounts of required fresh carbon dioxide and the fact that the mixtures obtained with the CO₂-extraction still contain for example chlorophyll, lipids and vegetal hormones, tanning agent etc.

In patent DE 3103617 A1 of year 1982 a method using 80 to 90% ethanol as solvent for extracting bitter and tanning agent rich hops extracts for use in the brewing industry is described, which application however requires in a further method step to separate the tanning agent portion by treatment with water vapour. The high labour intensity and energy demand are adverse, since a plurality of process steps have to be carried out.

All above mentioned extraction methods have the disadvantage that with the extraction of hops (umbels) with super critical carbon dioxide or with mixtures of water and organic solvents, large amounts of residues remain and the extracted (obtained, respectively) hops extracts have as a rule a high viscosity (honey like). Moreover, the thus obtained extracts still contain chlorophylls, lipids, etc. Consequently, there are multiple differing methods available by which means the desired components from the hops can be separated under constant conditions. These methods are however of economic and operational reasons, adverse, since the required devices are expensive and complicated as well as the control of the method is elaborate.

Therefore, there exists the requirement for alternative methods for separation of vegetal (plant, respectively) materials (ingredients, respectively), which overcome the above mentioned disadvantages of the chromatographic and extractive separation methods of the prior art. Such a method should only have a comparatively moderate amount of solvents, so that at least partly it can be automated comparatively easily. Beyond that, as intended by the present invention, a separation method should allow a selective enrichment or isolation of specific vegetal materials from a mixture of natural material in a technical scale in a simple and economic way.

The present invention solves the object by providing an extraction method for classified extraction and isolation of vegetal (plant, respectively) materials (ingredients, respectively) by means of multiple elution processes, which steps are comprising: crushing of vegetal (plant, respectively) basic materials comprising the vegetal and/or animal materials and/or providing the vegetal basic materials in fluid form, filling of an extraction vessel with the crushed vegetal basic materials and/or with the vegetal basic materials in fluid form, wherein the extraction vessel has at least one inlet and at least one outlet, wherein for said crushed material solely one or more retention devices are arranged upstream said at least one outlet, performing a first continuous elution process with a first solvent or solvent mixture, performing a second continuous elution process with a second solvent or solvent mixture, wherein the second solvent or solvent mixture is different from the first solvent or solvent mixture, optionally performing further continuous elution processes with a further solvent or solvent mixture, wherein each further solvent or solvent mixture is different from each solvent or solvent mixture used before.

The present invention combines processes occurring in the paper chromatography (partition chromatography) with the processes being significant in the case of extraction methods. The invention relates also to an elution method by means of a multi step elution for debonding of vegetal (plant, respectively) materials (ingredients, respectively) from the binding on the vegetal (plant, respectively) self-cellulose, as stationary phase, of the molecules to be eluted. For mobilising of the vegetal materials from the binding on the vegetal self-cellulose a water/ethanol mixture is applied step wise, but not as gradient, with the aim of extraction of extracts having enriched active agents up to pure active agents in technical scale, to provide these for use in the brewing economy, pharmacy, biotechnology, medicine, food chemistry as well as food technology and in the cosmetics.

The present invention rely essentially on the realisation that an extraction as most important component contains the vegetal self-cellulose as solid/stationary phase and matrix, respectively. In this connection, the self-cellulose is an indispensable, integral constituent and is capable for extraction (elution) of pure, vegetal materials. Differing binding forces, with which vegetal materials are bound on the self-cellulose, allow the step wise extraction of the vegetal materials by changing the polarity of the eluent. The specific, biophysical interactions between the self-cellulose and the materials are exploited to extract in a series of preferably few process steps and in a preferably preserving way with high yield, low energy input and simple, apparative complexity—and therefore cost saving—materials of the plants (plant products) either as substance groups or in pure form for use in the food industry and in other branches of industry. The materials can be dissolved away in a single step sequence.

The present invention further provides an extraction method for classified extraction and isolation of hops material by means of multi elution processes, which has the following steps: crushing of the hops materials and/or providing of the hops materials in fluid form, filling of an extraction vessel with the crushed hops material and/or with the hops material in fluid form, performing of a first continuous elution process with a first solvent or solvent mixture, performing a second continuous elution process with a second solvent or solvent mixture, wherein the second solvent or solvent mixture is different from the first solvent or solvent mixture, optionally performing further continuous elution processes each with a further solvent or solvent mixture, wherein each further solvent or solvent mixture is different from the solvent or solvent mixture used before.

The inventive extraction method is suitable for an extraction of different vegetal basic materials, comprising vegetal materials of interest, for example for vegetal raw materials and semi-industrial or technical products from vegetal materials, respectively and also for waste material from production processes, having vegetal origin. (In the following all such basic materials or mixtures therefrom are referred to as extraction goods.)

The inventive method qualifies in a favourably way for a separation of sensitive chemical compounds or compound mixtures, which easily decompose in the presence of established column filling materials or merely elute with dissatisfied yield during chromatographic methods.

In the drawings, shows:

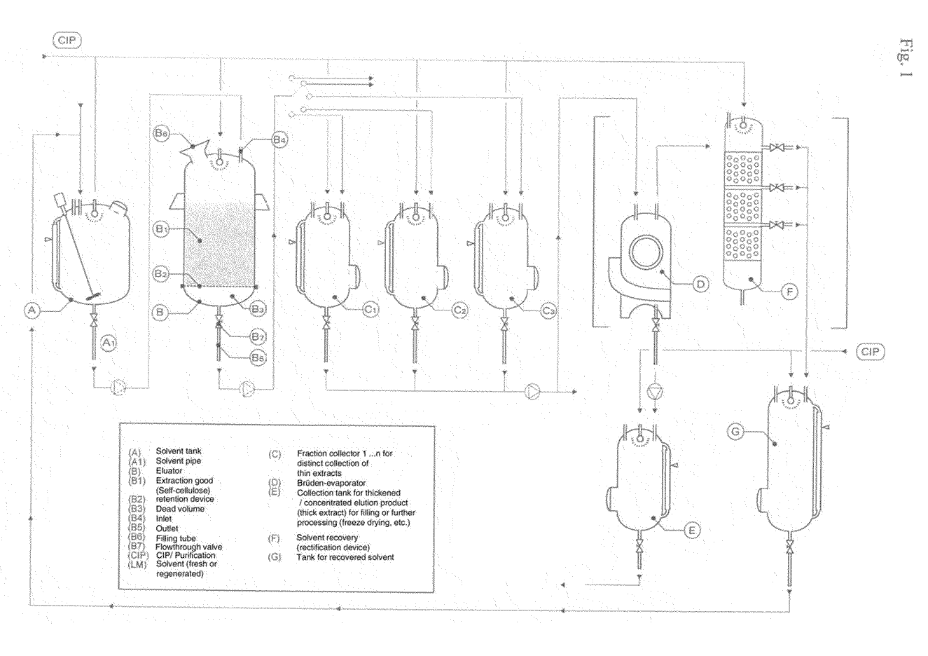

FIG. 1: a schematic view of an extraction method according to the present invention, relying on a production facility according to the prior art e.g. with the components A-G. A suitable consecutively coupling of the components ensure a stepwise elution of pure substances (agent, respectively) with purpose of separation and extraction of the same. The most important component is the eluator (B), containing the self-cellulose (B1) as stationary phase and at the same time as vegetal raw material for the extraction of ingredients.

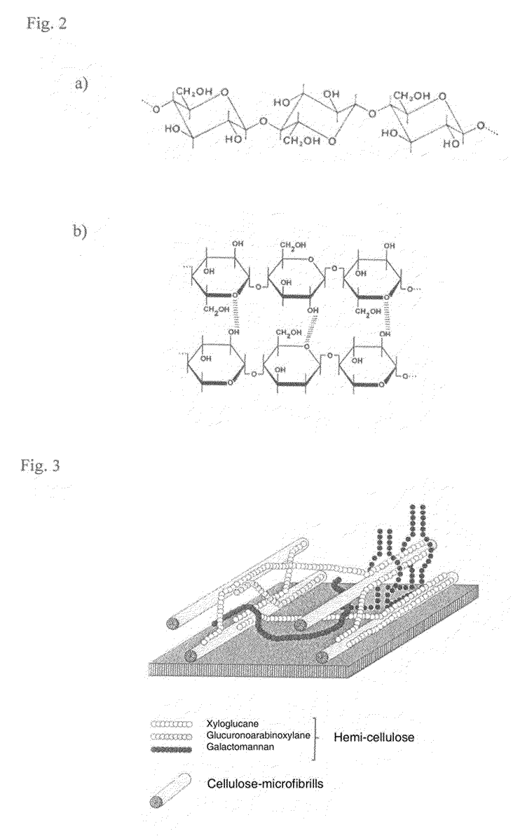

FIG. 2a: a polysaccharide configured of 1,4-linked glucose molecules, and b: an illustration of hydrogen bridges in the polysaccharide.

FIG. 3: a model of the vegetal primary cell wall (modified according to Markus Pauly, Max Planck Institute for Molecular Plant Physiology).

The present invention provides an extraction method for classified extraction and separation of vegetal material by means of multi elution processes. The method comprises in this connection the steps of crushing of the vegetal basic material comprising the vegetal material and/or providing the vegetal basic material in fluidic form: filling of an extraction vessel with the crushed vegetal basic material and/or with the vegetal basic materials in fluidic form, wherein the extraction vessel has at least one inlet and at least one outlet, wherein for said crushed material solely one or more retention devices are arranged upstream said at least one outlet, performing a first continuous elution process with a first solvent or solvent mixture, performing a second continuous elution process with a second solvent or solvent mixture, wherein the second solvent or solvent mixture is different from the first solvent or solvent mixture, optionally performing further continuous elution processes with a further solvent or solvent mixture, wherein each further solvent or solvent mixture is different from each solvent or solvent mixture used before.

The basic material is preferably in dry form to exploit the advantageous properties of the self-cellulose, e.g. as column material.

The continuous elution processes are preferably carried out with solvents and solvent mixtures, respectively, having decreasing polarity. In this way, the first solvent can be water for example tap water. The second solvent or solvent mixture can be a water/alcohol mixture and thus having a polarity lower than the first solvent.

The selection of suitable solvents and solvent mixtures, respectively, further preferably ensure that the structure of the self-cellulose is preserved over the total extraction process and that no disintegration of the same occurs.

The term “extraction method for classified extraction and separation of materials” comprises, that a reproducible separation of the material of the applied basics material is provided by the inventive method and a separation to a specific compound mixture, that means, is carried out to a specific class of compounds with essentially consistent chemical characteristics, particularly with an essentially consistent solubility behaviour, or is carried out to a specific compound in pure or essentially pure form. The term “compound in essentially pure form” comprises that the weight of this compound represents at least 60% by weight, preferably at least 90%, preferably at least 95% of the total weight of the observed (if necessary further purified) fraction, referred to the dry weight of the observed fraction and compound substance.

The inventive extraction method rely in this connection on a simple production facility with the components A-G. A suitable consecutive coupling of the components (see FIG. 1) ensures a stepwise elution of pure material with the purpose of separation and extraction of the same. The most important component is the eluator (B), containing the self-cellulose (B1) as stationary phase and at the same time as vegetal raw material for the extraction of the material. The vegetal material is more or less strongly bound to the self-cellulose of the plant material.

After the elution has been carried out the self-cellulose can even be used again in a different occupancy, so to speak as chromatography material for example with good success for the separation of vegetal material, which is not bound to just this self-cellulose in its natural condition. So for example the self-cellulose of hops can be applied for the separation and purification of natural material from apple juice. This example stands for the elution of vegetal material from any vegetal raw material under application of the self-cellulose of hops.

The elution is carried out by means of one or multi elution processes under the successive, stepwise application—but not as gradient—of water, one or more water/alcohol mixtures and pure alcohol as mobile phase. The single consecutively running process steps are to be described as follows: 1. Crushing (grinding, powdering, chaff) of the dried vegetal material comprising self-cellulose as main component. 2. Filling the eluator (B) through the filler pipe (B6) with the powdered, vegetal (moist or dry) basic material, wherein the eluator has at least an inlet (B4) and at least an outlet (B5) with control valve (B7). Upstream of an outlet are disposed one or more retention devices (sieve or filter plates, B2), on which the material is packed. 3. Swelling and flushing under application of tap water, wherein the vegetal self-cellulose is binding water and hence is swelling. As a result of this “watering” the conditioned self-cellulose is obtained, which now in the scope of the further performance of the method is effective as stationary phase and allows for a chromatographic or chromatographic like separation of the vegetal material in the interaction with the adequate elution solutions and solvent mixtures, respectively. The flushing water obtained by conditioning of the self-cellulose contains contaminations (bacteria, yeasts and harmful substances) and therefore is discarded. 4. Afterwards in the fifth work step again water, now for elution, is directed through the material (extraction good) to be eluted, in fact as long as the water soluble ingredients are dissolved completely and are in the eluate (fraction 1). The thus obtained fraction 1 is pumped through pipe (B5) into the collection vessel (C1) and is collected there. 5. In the following work steps of the stepwise elution eluents are produced in the solvent tank A and directed over the extraction good residing in vessel B. By switching to different mixing ratios water:alcohol the different vegetal materials are successively eluted pure or in classes and groups, respectively and collected in the corresponding collecting vessels C2, 3, . . . n. Each elution step and each elution stage, respectively is continued as long as the respective class of material is dissolved completely from the self-cellulose. Not until thereafter the next stage of the elution process begins.

It is advantageous that all elution steps can be carried out under normal conditions, that is at room temperature and normal pressure, wherein room temperature corresponds to a temperature between 20 and 24° C., preferably 22° C. and the term normal pressure comprises a pressure of 950-1060 mbar, preferably 980-1030 mbar. Consequently, the material can on the one hand be isolated in a gentle manner and on the other hand with low energy input. The present method can be carried out for acceleration admittedly also at increased or decreased pressure, the temperature can according to the requirements also be increased and decreased, respectively over room temperature. So a decreased temperature can for example influence favourably the stability of a material. Organic solvents are considered as eluents being miscible with water, in particular those being miscible in any ratio with water. Therefore, alcohols (such as methanol, ethanol, isopropanol, n-propanol, etc.) and ketones (such as acetone, etc.) are used preferably. However, ethanol is preferably applied, which is for food technological reasons most unobjectionable.

The difference of the consecutive elution steps resides in the stepwise decrease of the polarity by increasing the percentage of an organic solvent in the mixture with water. The percentage composition of the solvent mixture is optimised in that, that for the elution of the different groups of vegetal material a most appropriate solvent mixture is provided to separate the pure vegetal material in an optimal way. A respective sequence of solvent mixtures allows to consecutively extract and collect separately all interesting vegetal material in the vessels C2, 3, . . . n. After having carried out the elution and debonding from the self-cellulose in this way the obtained vegetal material is so pure, that following purification methods, such as for example chromatographic separation methods, etc., may be simplified or totally omitted.

The principle of the separation using of the self-cellulose is practically applicable to all known vegetal raw materials. The solvent mixtures have to be adapted to the specific extraction good regarding to the volume percentage of the components corresponding to the material consecutively to be extracted. The volume ratios of both solvent components vary between 0% water and 100% pure alcohol and organic solvent, respectively. The temperature can vary between 0° C. and 100° C., the pressure between 10 mbar and 800 mbar. The physical conditions are also modified and optimised for specific applications as the cases arise.

If the vegetal raw material to be eluted contains essential oils or other specific valuable volatile material, it is, moreover, provided to direct water through until the easily volatile components are totally or partly removed, before flushing and swelling the self-cellulose and before elution of the vegetal material. In this case it is required to connect the elution device with the condenser, conveniently directly downstream of the eluator, so that the water vapour loaded with the essential oils or other volatile components condenses and the easily volatile components can be extracted by phase separation. In this connection it is possible to direct either the water vapour from above downwards and from below upwards through the eluator, wherein in these cases a thermal isolation of the eluator and the possibility for heating the eluator must be given so that during the vapour treatment there does not occur any condensation of the fragrance in the eluator.

Self-cellulose is present in all plants as main component of the cell walls. It is the structural substance of plants. Chemically seen the self-cellulose is a non branched polysaccharide, formed chain-like of beta-glucose molecules (see FIG. 2). These chains consist of more than 10.000 molecules of glucose. Between parallel running chains hydrogen bridges are formed, so that three dimensionally arranged, crystalline structures occur. In plants, however crystalline alternate with non crystalline, so called para-crystalline portions, wherein so called micelles are formed, in which the single cellulose chains are running disordered, non-parallel, whereby hydrogen bridge formation is hampered. Due to their high molecular structure self-cellulose is insoluble in water and in most organic solvents.

The specific characteristics of the self-cellulose, particularly regarding its surprising capacity to bind material, rely on its specific structure in the vegetal cell wall. The cell wall consists of multiple layers of the cellulose, which may differ in their orientation and in which partly further stabilising substances, such as for example lignin, are stored (see FIG. 3).

Molecular main components of each cell wall are polysaccharides. In the cell wall a crystalline, fiber like component, the so called cellulose micro-fibril, forming a watery, gel like matrix, is allowed to be detected. This gel like matrix consists mainly of hemi-cellulose and pectins. The network of different hemi-celluloses has a high binding affinity for cellulose and therefore forms a cellulose/hemi-cellulose network having tensile strength. Presumably this network is responsible for the stability of the cell wall. Pectins form a further network and consist of structurally diverse individual modules (see FIG. 3), all of which are characterised by the presence of a negative charged sugar of galacturonic acid. The pectin network determines the porosity of the cell wall and therefore the kind and size of the material which can pass the cell wall. Furthermore, the pectin network is important for the binding of ions and charged molecules, but also for the stability of the cell wall. Besides polysaccharides in some cells are also glycol-proteins components of the cell wall. Additionally, in the secondary cell wall (it develops in the growth of plants from the primary cell wall) a large amount of a poly-phenyl substance, the so called lignin, is stored. Lignin imparts to the cell wall hardness and water-repellent characteristics. The volume enclosed by the cell wall is practically completely filled by the protoplast (plant cell). The protoplast is the living part of the plant cell enclosed by the cell membrane, in contrast to the dead cell wall.

When fresh or dried vegetal tissue is treated with water or organic solvents the protoplast is destroyed then at the latest. The vegetal material formed in the protoplast is more or less completely brought into solution, while the cell walls, forming an assembly supporting the vegetal (plant, respectively) tissue do not dissolve. The industrially utilised cellulose is extracted from natural material. For specific applications, for example as solid phase in chromatography, the OH groups are for example substituted by sulfonates to provide new polymers (“New Polymers from Cellulose Sulfonate”. Heine, T. et al., J. Pulp & Paper Science) 25, 136-140 (1999)).

The selected and crushed extraction good can either be used directly or however be applied together with appropriate carrier or disaggregation materials, like sand, diatomaceous earth, cellulose or other appropriate and vis-à-vis the solvents to be used sufficiently durable materials. The appropriate crushing level respectively the requirement for use of carrier and disaggregation material, respectively is dependent from the extraction good and can be carried out according to the general knowledge of a skilled person. To the basic material can for example be added between 1 and 90% by weight, preferably between 5 and 30% by weight of carrier and disaggregation material, respectively, each referred to the dry substance.

The thus prepared material is then filled into an appropriate extraction vessel. Such an extraction vessel can at least have an inlet and outlet, wherein upstream of the at least one outlet solely one or more retention devices for the crushed material and/or the carrier material can be disposed. Such a retention device can for example be a sieve with pores, particularly a sieve having 3 pores. Alternatively, for example a cotton plug can be disposed upstream of the outlet, a Büchner-hopper (suction funnel, respectively) if necessary can be applied in combination with filter paper or another appropriate retention device according to the general knowledge of a skilled person may be selected. Such a retention device results preferably in no or essentially no separation and/or retention of the dissolved material contained in the extract. The composition of the extract after passage through the retention device should essentially equal the composition before the passage through the retention device. This may for example be detected in that, that it is determined, that the content of the three quantitative main components of the extract after passage through the retention device does not deviate more at a time of ±5% of the content before the passage.

Particularly, the extraction vessel can be in flow direction of the extract below the layer comprising the basic material in crushed and/or fluidic form be free of a layer of added material having separation characteristics upstream of the retention device and/or the outlet. The term “added material having separation characteristics” comprises in the present application substances for a chromatographic separation particularly known to the skilled person, for example diatomaceous earth or aluminium oxide, and/or solid material supplied with chemical compounds, for example ion exchange beads. Such materials having separation characteristics are, as known to the skilled person, added to containers and vessels. Particularly, it is noted that from the term “added material having separation characteristics”, devices integrally connected with the extraction vessel should not be comprised, for example plates or so called fits, for example of ceramic or glass material.

The extraction is then carried out by directing through solvents or solvent mixtures of two or more solvents, the composition of which can vary, wherein the change of the solvent or solvent mixture is dependent on which material (ingredients, respectively) or which mixture of material is to be extracted from the extraction good.

As solvent each known solvent can be used, wherein the solvent is preferably a solvent suitable for an extraction of food, particularly if the substance(s) of the extract are intended for the human consumption. Moreover, if desired the solvent or solvent mixture can be adjusted with an acid or base to a specific pH-value before the extraction. The solvent or solvent mixture of the succeeding elution processes can have an increasing, a decreasing or an essentially constant polarity and/or an increasing, a decreasing or an essentially constant pH-value.

With the first, second and optional third, fourth, fifth or further elution process an elution can for example be carried out with at least one solvent or solvent mixture, selected from the group consisting of water, mixture consisting of water and ethanol, mixture comprising at least 70% by weight, preferably at least 80% by weight of water and/or ethanol, and ethanol.

In contrast to established extraction methods the extraction good in the inventive extraction method is thus not suspended in a solvent or solvent mixture, wherein the suspension is subsequently filtered to separate the solvent together with the extracted material from the residue, but the content components are dissolved by and by from the extraction good in a permanent or continuing elution process with changing solvents and/or solvent mixtures of different composition. In doing so, the method can subject to on the one hand desired and on the other hand undesired or the extraction potentially disturbing material be controlled in such a way, that for example the undesired and/or disturbing material are dissolved with a first solvent or solvent mixture before the extraction of the or the actual interesting material (ingredients, respectively) is starting. Conversely, the extraction can be controlled in such a way that the undesired substance(s) remain(s) in the extraction good until completion of the extraction of the fraction of interest. The term “continuous elution process” comprises, that during the elution process the extract drain is preferably not disturbed and a constant continuous extract drain is carried out. Occurring disruptions should, where appropriate not exceed a time period of 10 minutes, preferably 1 min.

If desired the extract fractions obtained at a time can be partly or completely recombined after their extraction. Particularly, it is possible, that from one or more fractions one or more undesired substances are separated according to methods known to the skilled person, and the such processed or purified fractions are recombined with the other extraction fractions, to obtain an extract freed from specific undesired, for example unhealthy substances.

In this connection it is of high interest, that substances or substance mixtures obtained from extract fractions or combinations of extract fractions can show specific action characteristics of hops by synergistic interactions or by exclusion of substances with converse action. With the inventive hops extracts it is also advantageous that they can be used for the production of beers, which meet the requirements of the German purity law.

Particularly, an advantage of the inventive method lies in the control possibility of the extraction, such that a successive dissolving of the material from the extract material is possible by appropriate solvents and solvent mixtures, respectively, and thereby subsequent purification methods such as for example chromatographic separation methods are omitted, or however are simplified. If desired the inventive methods can naturally also be carried out under a protective atmosphere using degassed and/or with protective gas saturated solvents or solvent mixtures and if necessary with darkened vessels.

The inventive method is of particular advantage during a separation of material which comprises sensitive substances and substance mixtures, for example multiple unsaturated compounds or mono or polycyclic compounds in which a ring unit is substituted with more than one hydroxy or keto group, particularly for substances and substance mixtures comprising flavonoids or α-bitter-acids (for example humulone, cohumulone or adhumulone) or β-bitter-acids (for example lupulone, colupulone or adlupulone).

The multi step elution process can comprise at least two of the subsequent stage extractions, A) extraction with water, B) extraction with an ethanol/water mixture 25-35% by volume, preferably 29-31% by volume, particularly 30% of ethanol, C) extraction with ethanol/water mixture 45 to 55% by volume, preferably 49 to 51% by volume, particularly 50% of ethanol, D) extraction with ethanol/water mixture with 75 to 85% by volume, preferably 79 to 81% by volume, particularly 80% by volume of ethanol, E) extraction with ethanol/water mixture with 90 to 96% by volume, preferably 94 to 96% by volume, particularly 96% of ethanol, each referred to the total volume of the ethanol/water mixture. Preferably, the inventive method comprises for providing a higher fractionation at least three, at least four or all five above mentioned stage extractions. Optionally, one or more other stage extractions can be carried out according to the knowledge of the skilled person before, between or after the above mentioned stage extraction steps.

At stage A an extraction of tanning agents, sugar containing compounds, α-bitter-acids, pre- and post-humulone and pre- and post-lupulone, respectively is carried out. This fraction can for example be used as foaming agent and comprises the substance in beer causing headache.

At stage B α-bitter-acids are extracted. If a high purity is desired a further purification can be carried out where appropriate according to the knowledge of the skilled person. Fraction 2 can for example be used as foaming agent and/or as preservative. Furthermore, fraction 2 shows an activity directed against staphylococci, having multiple antibiotic resistances (MRS) and against Heliobacter pylori and/or can be applied as a pesticide.

At stage C flavonoids such as for example xanthohumol are extracted. Where appropriate enriched flavonoids or flavonoids in pure form or in a form having high purity can be obtained by successive routine laboratory methods, such as for example VLC (vacuum liquid chromatography).

At stage D α-bitter-acids and β-bitter-acids are extracted. If desired hops extract (fraction 4) obtained at stage D can be further separated according to methods known to the skilled person, wherein pure bitter-acids respectively enriched lupulone-extracts and/or enriched humulone-extracts are obtained. Particularly, this can for example be carried out by extraction of an organic phase of the mixture of α-bitter-acids and β-bitter-acids with a watery phase, having acidic, neutral or basic pH-value, for example by an acid-base separation process known to the skilled person. The hops extract of stage D and/or the substances contained therein, particularly α-bitter-acids and β-bitter-acids have sedative and sleep supporting characteristics and can therefore be used for the production of a sedative or a sleep supporting medicament.

At stage E lipids and chlorophylls are extracted and further water insoluble or in a mixture of water and ethanol having an ethanol content of less than 90% insoluble materials (ingredients, respectively).

If desired, the inventive method can also be carried out in such a way, that at least two, preferably at least three, preferably at least four or five extraction steps are carried out according to the sequence of stage extraction step E) extraction with ethanol/water mixture with 90 to 96% by volume, preferably 94 to 96% by volume, particularly 96% of ethanol, D) extraction with ethanol/water mixture with 75 to 85% by volume, preferably 79 to 81% by volume, particularly 80% by volume of ethanol, C) extraction with ethanol/water mixture 45 to 55% by volume, preferably 49 to 51% by volume, particularly 50% of ethanol, B) extraction with ethanol/water mixture 25-35% by volume, preferably 29-31% by volume, particularly 30% of ethanol, each referred to the total volume of the ethanol/water mixture and A) extraction with water.

If desired, the respective extract fractions of the above mentioned steps A-E can regarding specific materials be further enriched with or depleted of or the material can be extracted in purity therefrom, which is appropriate for the respectively desired application. Therefore, different methods known to the skilled person, for example, chromatographic purification methods can be used.

Particularly, the inventive method allows a complete or partial separation of the phytohormones 6-prenylnaringenin and 8-prenylnaringenin occurring in hops which are substances suspected and having been verified, respectively that they act hormone like in humans. The action is similar that of female hormones from the group of estrogens. Especially, it has been verified for 8-prenylnaringenin that it is acting like the 17β-estradiol. To avoid undesired or unhealthy effects on consumers, particular male consumers, however also specific female consumers, there is the desire for products on hops-basis from which these ingredients (materials, respectively) are completely or partly removed. This applies not only for beer or brewery products, but also for hops product containing cosmetics and pharmaceuticals.

For this purpose an inventive extraction method is carried out, which comprises the above mentioned stage extraction step C, wherein in the stage extraction step C 6-prenylnaringenin and 8-prenylnaringenin are separated. A hops extract freed from 6-prenylnaringenin and 8-prenylnaringenin, can than be obtained while the extracts are combined, which are extracted in the at least one further (preceding and/or succeeding) stage extraction step, wherein optional also the hops extract of step C freed by means of common methods known to the skilled person from 6-prenylnaringenin and 8-prenylnaringenin, can be added.

Particularly, the present invention refers therefore, also to a use of a phyto-hormone free or mixture of hops materials depleted of phyto-hormone, preferably of a mixture of hops materials being free from 6-prenylnaringenin and/or 8-prenylnaringenin or depleted of 6-prenylnaringenin and 8-prenylnaringenin for the production of beverages and brewery products, particular of beer, which can also be produced according to the German purity law,

In this way the present invention allows in a reproducible manner the extraction of a hops extract, which is free from 6-prenylnaringenin and 8-prenylnaringenin or is depleted thereof to a great extend. In the present invention the term “depleted of to a great extend of a substance” means that the substance represents a content being less than 50%, preferably less than 80%, preferably less than 95% of the content of the substance in the basic material, each referred to the dry weight. The term “to deplete a substance” (“to enrich a substance”) means that the substance is present in a content of less than 10% (more than 110%), preferably less than 40% (more than 200%), preferably less than 80% (more than 300%) of the content of the substance in the basic material, each referred to the dry weight.

The present invention further provides that at an elution step an extract is obtained, consisting of the water soluble hops material (ingredients, respectively) particularly tanning agents. For this purpose the extraction good is extracted in a first step with water and the thus obtained hops extract is collected.

The present invention therefore provides methods, which surprisingly allow in a very simple but most effective way a separation or enrichment of specific natural products, particularly flavonoids. Preparing fractions enriched with flavonoids, for example xanthohumol, is desirable due to its cell protecting potential. So flavonoids are applied alone or in combination with other active substances, such as for example vitamins, in the prevention and treatment of cell aging, respectively.

Moreover, the inventive method provides the possibility of a comparatively low solvent demand and provides the possibility of a automation.

In particular, the present invention allows the extraction of a substance mixture or a substance selected from the group consisting of xanthohumol, hops extract depleted of xanthohumol, hops extract enriched with xanthohumol, 6-prenylnaringenin, hops extract depleted of 6-prenylnaringenin, hops extract enriched with 6-prenylnaringenin, 8-prenylnaringenin, hops extract depleted of 8-prenylnaringenin, hops extract enriched with 8-prenylnaringenin, adlupulone, hops extract depleted of adlupulone, hops extract enriched with adlupulone, colupulone, hops extract depleted of colupulone, hops extract enriched with colupulone, lupulone, hops extract depleted of lupulone, hops extract enriched with lupulone, humulone, hops extract depleted of humulone, hops extract enriched with humulone, adhumulone, hops extract depleted of adhumulone, hops extract enriched with adhumulone, cohumulone, hops extract depleted of cohumulone, hops extract enriched with cohumulone, α-bitter-acid mixtures, hops extract depleted of α-bitter-acids, hops extract enriched with α-bitter-acids, β-bitter-acid mixtures, hops extract depleted of β-bitter-acids, hops extract enriched with β-bitter-acids, and mixtures thereof.

In this connection specific hops material can be obtained in a pure form or in a form with high purity (for example having a purity of 85% or more, preferably of 90% or more, preferably of 97% or more). Additionally, with the present invention a mixture of α-bitter-acids in pure form or in a form of high purity, a mixture of α-bitter-acids enriched with humulone, a mixture of β-bitter-acids enriched with lupulone or humulone or lupulone in pure form or in a form of high purity can be obtained.

The present invention further refers to the above mentioned substances and substance mixtures. In the present invention the term hops extract can refer either to the solvent containing hops extract as well as to the substance mixture (substance) obtained therefrom.

These hops ingredients or substance mixtures of hops material can be applied for many applications. A particular important application resides in a use of one or more of the above mentioned hops ingredients or one of the above mentioned enriched with or depleted of substance mixtures of hops material for the production of a sleep supporting and/or sedative medicament. In this connection α-bitter-acid mixtures, hops extract depleted of α-bitter-acid, hops extract enriched with α-bitter-acid, β-bitter-acid mixtures, hops extract depleted of β-bitter-acid, hops extract enriched with β-bitter-acid and mixtures thereof are preferably used.

Such a medicament can for example facilitate to fall asleep, but also to prolong the sleep phase of a person. Such a medicament is particularly intended for the application in humans and mammals. The specific amount of one or more hops ingredient(s) or one or more enriched or depleted substance mixture(s) of hops material can be chosen according to the general knowledge of the skilled person. Preferably such a medicament is free of 6-prenylnaringenin and 8-prenylnaringenin or contains less than 5% by weight, preferably less than 3% by weight of 6-prenylnaringenin and 8-prenylnaringenin referred to the total dry weight of the hops material.

Such a medicament is preferably suited for the oral intake. The specific formulation of the medicament can for example be in form of tablets, capsules or in a fluidic formulation form. Administration can be carried out for example orally, by means of i.v. or i.m. injection, administration by spray, nasally, by inhalation, vaginally, anally or topically or in another administration form known to the skilled person. Such a formulation can for example contain a dose of a hops material or of a mixture of hops ingredients in the range of 0.001 g to 10 g, wherein such a formulation is taken once or several times a day. Optionally, the medicament can comprise further drug agents known to the skilled person, particularly known drug agents for supporting sleep or as sedative, and suitable formulation additives.

Furthermore, one of the above mentioned hops ingredients or one of the above mentioned substance mixtures of hops material can be used for the production of a medicament for treatment and/or prevention of diseases caused by infection of staphylococci, particularly of staphylococci having a multi antibiotic resistance, and/or for treatment and/or prevention of diseases caused by an infection of helicobacter pylori. For this purpose α-bitter-acid mixtures, hops extract depleted of α-bitter-acid, hops extract enriched with α-bitter-acid, β-bitter-acid mixtures, hops extract depleted of β-bitter-acid, hops extract enriched with β-bitter-acid and mixtures thereof are preferably used.

Such a medicament is preferably free of 6-prenylnaringenin and 8-prenylnaringenin or contains less than 5% by weight of 6-prenylnaringenin and/or 8-prenylnaringenin, preferably less than 3% by weight of 6-prenylnaringenin and/or 8-prenylnaringenin, each referred to the total dry weight of the hops material and the total dry weight of 6-prenylnaringenin and/or 8-prenylnaringenin. The specific formulation of the medicament can for example be in the form of tablets, capsules or in a fluidic formulation form. Administration can for example be orally, by means of i.v. or i.m. injection, administration by spray, nasally, by inhalation, vaginally, anally, or topically or in a further administration form known to the skilled person can be carried out. Such a formulation can for example contain a dose of a hops ingredient or a mixture of hops material in the range of 0.001 to 10 g, wherein such a formulation can be taken once or several times a day. Optionally, the medicament can comprise further drug agents known to the skilled person, for example antibiotics, and/or known drugs for the combat of helicobacter pylori, and appropriate formulation additives.

Moreover, the mentioned hops ingredients or one of the above mentioned substance mixtures of hops material can be applied as preservative. A use as preservative for food and cosmetic products will be suitable and accepted by the consumer to a high degree. For this purpose α-bitter-acid mixtures, hops extract depleted of α-bitter-acid, hops extract enriched with α-bitter-acid, β-bitter-acid mixtures, hops extract depleted of β-bitter-acid, hops extract enriched with β-bitter-acid and mixtures thereof are preferably used. For this purpose the products to be preserved can for example be added between 0.001 and 40% by weight, preferably between 0.005 and 2% by weight of hops material or substance mixtures of hops material, referred to the weight of the products to be preserved. Moreover, the hops material or substance mixtures of hops material can be applied also as mixture with one or more further inorganic and/or organic preservatives.

The hops material mentioned or one of the above mentioned substance mixtures of hops material can be used as pesticide, particularly as insecticide. For this purpose α-bitter-acid mixtures, hops extract depleted of α-bitter-acid, hops extract enriched with α-bitter-acid, β-bitter-acid mixtures, hops extract depleted of β-bitter-acid, hops extract enriched with β-bitter-acid and mixtures thereof are preferably used. Thereby, the specific formulation of the pesticide is carried out according to the knowledge of the skilled person. Particularly, the pesticide or insecticide formulation can comprise further substances or substance mixtures having a pesticide or insecticide effect.

The present invention further refers to beer, produced by a method in which an inventive hops extract is used. In this connection beer can be any kind of beer which is produced according to any method known to the skilled person. The method can for example comprise the steps of mashing, refining, hops cooking and alternatively of cooling and fermenting.

The invention will now be illustrated in detail by the following example, which however only illustrates the invention and should not limit its scope of protection.

### EXAMPLES

### a) Preparation of the Extraction Good

The application of the invention, i.e. the stepwise elution method utilising the central function of the vegetal self-cellulose should be presented by the example of the extraction and separation of hops ingredients and hops material.

Dried hops, hops-lupulin and semi technical or technical hops products, such as for example the commercially available hops pellets, being obtained after alcoholic or CO₂-extraction, represent the basic material. The above mentioned dry vegetal raw materials are fine crushed for example by an Alpin-Rotoplex cutting mill of type Ro 20/10 B. After this process the particles have a maximal size of 1 mm³. The optimal milling level is different and in fact dependent on the use of the hops or the use of the hops products obtained therefrom. The thus prepared material is filled into the elution vessel (B). It is minded that a filling of the elution vessel with the raw material is as homogenous as possible. This homogenous, densely packed filling and charging, respectively with extraction good should allow an improved separation of the hops ingredients by elution from the self-cellulose of the hops.

The solvent and solvent mixtures (alcohol-/water mixture), respectively are selected for each elution step in such a way, that the hops ingredients accumulate separately and are washed out (eluted, respectively) as single agent or in groups and classes, respectively. The elution can either be carried out as forward-elution with increasing percentage of the alcohol in the eluent or as backward-elution having decreasing alcohol percentage in the eluent.

### b) Performance of the Elution Steps in the Forward-Elution

Once the elution vessel (B) is filled by the filling tube (B6) with the extraction good (B1), the extraction good is layered over with tap water (drinking water quality) at room temperature. The water migrates through the extraction good, wherein the self-cellulose of the hops material is loaded with water and is therefore swelling. The self-cellulose of the hops is conditioned by this watering. During the conditioning with water the yeasts, germs and possibly still present traces of plant protectants are flushed away and are discarded.

Thereafter, pure water (drinking water quality) is once more directed over the elution good as eluent (solvent) LM1 as long as the water soluble ingredients are completely dissolved. The fraction (fraction 1) obtained in this way is pumped through a pipe B5 into the fraction collector (C1) and is collected there. Fraction 1 is directed over the evaporator (D) to evaporate the solvent. Water vapour is transferred into the rectification device (F) and recovered by distillation. The recovered solvent LM1 is collected in one or more solvent tanks (G) and can be reused. The concentrated elution product (thick extract) which remained in the evaporator is transferred into the collection tank. There the thick extract is provided for the subsequent processing or filling as (pre-)product. Fraction 1 contains the water soluble tanning agents. They include many chemically different compounds, which regarding to their chemical nature and biological action are ranked among others to the polyphenols and anthocyans and particularly have anti-oxidative action. Fraction 1 further contains sugar containing compounds, α-bitter acids (humulone, adhumulone, cohumulone, pre-humulone, and post-humulone) and other well water soluble hops ingredients. The sugar containing compounds can for example be applied as tranquilisers (sedative).

The performance of a second step of the elution process is carried out by means of a solvent mixture LM2, consisting of an ethanol/water mixture of 20 to 40% by volume, preferably having a content of 25 to 35% by volume, particularly having a content of 30% by volume ethanol. LM2 is produced in the solvent tank (A) by means of an agitation motor by mixing. LM2 provided in this way is directed through a tube (A1) through the inlet (B4) onto the extraction good. By elution with LM2 a small proportion of the α-bitter-acids (humulone, cohumulone, and adhumulone) in nearly pure form and a small proportion of the flavonoids (xanthohumol and isoxanthohumol) are eluted (fraction 2). Fraction 2 is transferred into the collection tank (C2) though tube B5. Fraction 2 is directed into the evaporator (D) and the method is continued such as already described in the case of the after-treatment of fraction 1.

Subsequently, the elution with a third solvent mixture LM3 follows consisting of an ethanol/water mixture having a percentage of 40 to 70% by volume, preferably 45 to 60% by volume, particularly 45 to 55% ethanol. At this elution stage (fraction 3) hops-flavonoids, such as for example xanthohumol, are eluted. Fraction 3 is collected in the fraction collector (C3). Production of the solvent LM3 is carried out by mixing in the solvent tank (A). Extraction good is layered over with LM3, the eluate is collected and fed to the extraction of thick extract. Recovery of the solvent is carried out as already described in the case of stages 1 and 2. Where appropriate, flavonoids in pure form or in a form having high purity can be obtained by subsequent application of common laboratory methods, such as for example VLC (vacuum liquid chromatography).

In a fourth elution process α-bitter-acids and β-bitter-acids in form of a mixture (fraction 4) are obtained under application of solvent mixture LM4 consisting of an ethanol/water mixture having a percentage of 70 to 90% by volume, preferably 75 to 85% by volume, and particularly 80 to 85% by volume ethanol. This fraction 4 is collected in fraction collector (C4). Fraction 4 can be used directly or after a 10-fold thickening as additive for beer, as active agent or as additive in the cosmetic and food sector. The product can either be a watery or alcoholic, even though thickened solution or a solid after further solvent removal.

Subsequently, yet an elution of the extraction good can be carried out with an ethanol/water mixture LM5, containing 90 to 96% by volume, preferably 94 to 96% by volume, and particularly 96% by volume ethanol. In this way chlorophylls and lipids as well as further not water soluble or in a mixture of water and ethanol having an ethanol content of less than 90% insoluble ingredients are obtained (fraction 5).

When in the eluting solvent and solvent mixture, respectively no dissolved substances are detectable the single elution steps are than completed. A stepwise performance of the above described elution stages provide fractions 1 to 5. The selective extraction of only a single fraction is also possible. When eluted, for example, the extraction good is at first eluted free of fractions 1 to 3 by LM3. Subsequently fraction 4 is obtained with LM4.

Preferably, the inventive method leads to a higher fractionation, if at least two, at least three, at least four or all five above mentioned stage elutions are carried out. According to the knowledge of the skilled person one or more further stage elutions can be carried out in an optimal manner, namely those comprising the elution range before, between or after the above mentioned stage elutions.

### c) Inverse Elution Method for Separation of the Hops Ingredients

In case of the inventive method the already previously described elution steps can also be carried out in the inverse sequence (inverse elution) in such a way, that the elution of the hops ingredients is carried out by means of one or more elution processes, i.e. by successive, stepwise application—but not as gradient—of alcohol, one or more water/alcohol mixtures and pure water as mobile phase. The successive running process steps in the inverse elution are as described as follows:

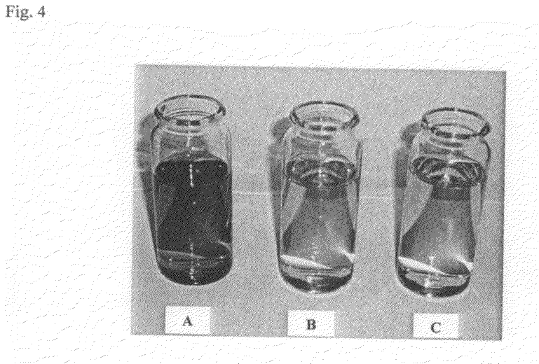

1. Crushing (milling, powdering, chaff) of the dried (semi-dried, fresh) vegetal material, containing the self-cellulose as stationary phase and main ingredient.
FIG. 4: Illustration of the colour of the fractions 5 (A), 4 (B), and 3 (C).
   2. Filling of the eluator (B) through the filling tube (B6) with the powdered vegetal (moist or dry) basic materials, wherein the eluator has at least one inlet (B4) and at least one outlet (B5) with control valve (B7). In any case upstream of the outlet opening are installed, as far as required also in the eluator, one or more retention devices (e.g. as sieve, filter plate or plug of glass wool) on which the crushed material is packed. The conditions under which the inverse elution is normally carried out are room temperature, normal pressure and the presence of air. In principle, the elution conditions can however be changed to that effect, that for processing at anaerobic conditions nitrogen atmosphere prevails or temperature changes and different pressures are present.

Once the elution vessel (B) is filled with the extraction good (B1) the extraction good is over layered with 96% ethanol at room temperature. In case of the inventive method the polarity change of the eluent for the purpose of stepwise elution of the vegetal ingredients can also be carried out in such a way, that at least two, preferably however at least four or five elution steps subsequently with an ethanol/water mixture (LM5), containing 90 to 96% by volume, preferably 94 to 96% by volume, and particularly 96% by volume ethanol. Under the influence of ethanol the hops cellulose does not swell (or not markedly). The filling level of the extraction good in the elution vessel keeps (almost) constant. In this way a part of the hops ingredients, particularly the hops flavonoids, and a large part of the α- and β-bitter-acids in form of a mixture as brown-green solution (fraction 5) is obtained (see FIG. 4, bottle A). Elution by means of LM5 is carried out as long as a colour change to green-yellow is observed.

In the following second elution process α-bitter-acids and β-bitter-acids, a part of the flavonoids and tanning agents (fraction 4) as a green-yellow solution (see FIG. 4, bottle B) are obtained under application of solvent LM4, consisting of an ethanol/water mixture of 70 to 90% by volume, preferably 75 to 85% by volume, and particularly 80 to 85% by volume ethanol. Due to the increasing water content in LM4 the self-cellulose of the hops is swelling clearly visible during this elution. The elution process is continued as long as a colour change to bright-yellow is carried out.

The elution with the third solvent LM3 follows, consisting of an ethanol/water mixture having a percentage of 40 to 70% by volume, preferably 45 to 60% by volume, particularly 45 to 55% by volume ethanol. In this elution stage a yellow coloured solution (fraction 3, see FIG. 4, bottle C) is obtained. In this fraction 3 the hops flavonoids, such as e.g. xanthohumol, a smaller part of the α-bitter-acids and β-bitter-acids and a large part of other hops ingredients are collected.

Performance of a fourth elution step by means of the solvent LM2 consisting of an ethanol/water mixture having a content of 20 to 40% by volume, preferably with a content of 25 to 35% by volume, particularly having a content of 30% by volume ethanol. By elution with LM2 the bright yellow fraction 2 is eluted, containing 90 to 95% by weight of a so far uncharacterised substance. The smaller percentage (<5%) consists of α-bitter-acids (humulone, cohumulone, and adhumulone), β-bitter-acids and flavonoids (xanthohumol) and tanning agents, respectively, which however are contained in a large amount in fraction 5.

Finally, an elution of the extraction good with pure water (drinking water quality) is carried out, namely with the solvent LM1. In this final step LM1 is directed as long as over the extraction good until the water soluble ingredients, being bright yellow, are completely dissolved (fraction 1).

Due to the increase of the water content in each of the five eluents the hops self-cellulose is swelling, such that the volume of the extraction good is extended with each elution step. The passage of the solvent is therefore slowed.

Description of the Fractions 1 to 5 and Detection of the Ingredients within the Fractions after Forward-Elution:

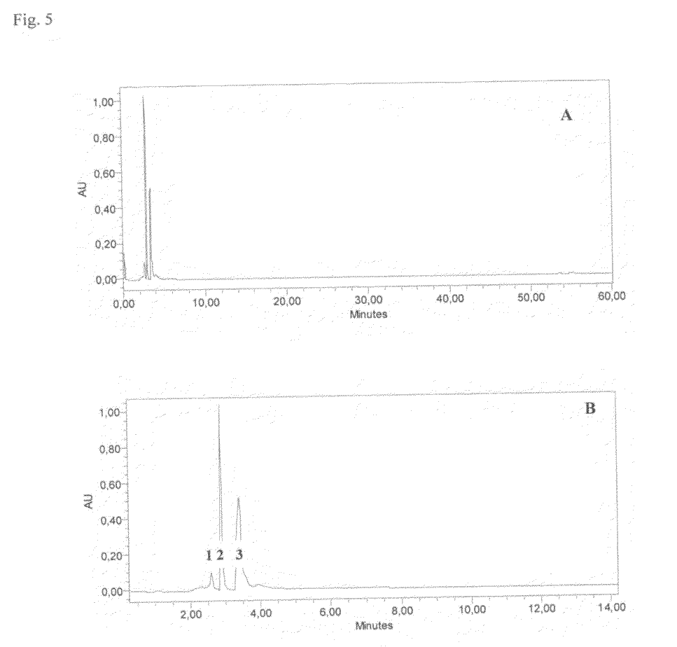

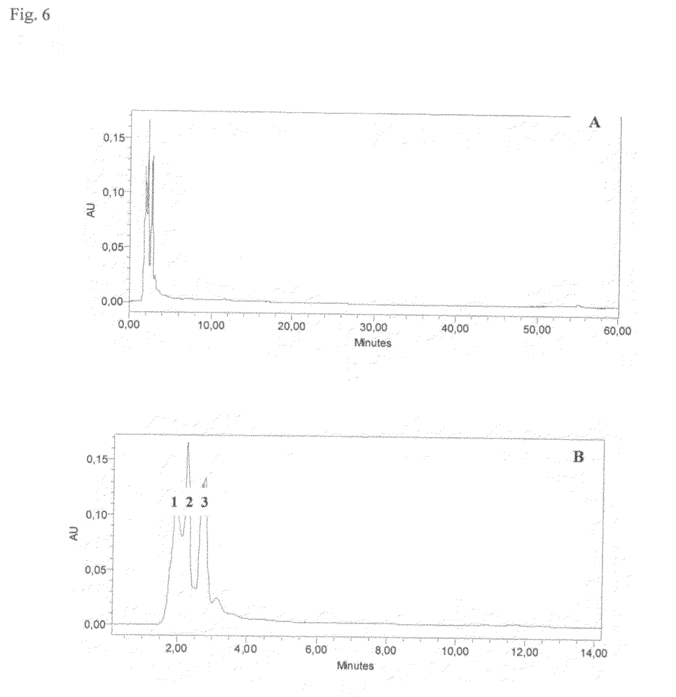

Fractions 1 to 5, obtained by means of the previously described elution steps show in specific limits a relative constant and reproducible composition of its molecular components. The fractions obtained under the conditions of the previously described elution steps are characteristic and reproducible for the separation method put under protection. The fractions in their composition of single agents form characteristic pre-products and products, respectively, put also under protection. The chemically different molecular components contained in the fractions are allowed to be separated completely into molecular entities and are obtained in pure form subsequently by application of known classical separation methods (e.g. HPLC and LC-MS). The exact molecular composition of each fraction can be determined by means of HPLC-diagrams. The dissolvable molecular components are measured at the wave length of 325 nm and characterised by the numbers 1 to 19. Known molecules are assigned to specific retention times. Unknown molecules are referred to as at the time unknown. The essential identification features, particularly the percentage proportions, are presented in tables.
FIG. 5: Illustration of fraction 1 in the HPLC-chromatogram of the forward-elution as complex band 1, 2, and 3 in the forerun. Image A not splayed, image B splayed.
FIG. 6: Illustration of fraction 1 in the HPLC-chromatogram of the forward-elution as complex band 1, 2 and 3 in the back-run. Image A not splayed, image B splayed.

In fraction 1 are the water soluble tanning agents, representing a particular substance class, to which many chemically different compounds are belonging, which due to their chemical nature and their biological action, are predominantly ranked among the group of the polyphenols and anthocyans.

The forerun of fraction 1 (see FIG. 5) eluted with pure water shows in the HPLC-chromatogram at least three bands and contains a hardly soluble, easily precipitable, light brown salt, which composition is still not defined and is not collected at the time because of unknown utilisation. The back-run (see FIG. 6) also eluted with pure water shows in the HPLC-chromatogram also at least three dissolved bands. As a result a highly hygroscopic substance and dark brown, highly foaming solution, respectively is obtained. The water is extremely difficult to remove from the solution, such that this product is normally present as a solution. The after-run of fraction 1 contains large amounts of sugar containing compounds, as well as other hops ingredients being well soluble in water. The complexity of the molecular composition of fraction 1 can be recognised in the HPLC-chromatogram of FIG. 5 (and 1 to 3) and FIG. 6 (band 1 to 3). The essential identification features, particularly the percentage proportions are illustrated in Tables 1 and 2.

TABLE 1
Identification features of the essential components
in fraction 1 (forerun) due to the measurements
in the absorption maximum at 325 nm.

| Elution band | Retention time | Proportion | |
|---|---|---|---|
| no. | (min.) | (% by weight) | Substance |
| 1 | 2.1 | 7.8 | unknown |
| 2 | 2.9 | 38.3 | unknown |
| 3 | 3.1 | 51.5 | unknown |
| Σ | | 96.6 | |

TABLE 2
Identification features of the essential components
in fraction 1 (back-run) due to the measurements
in the absorption maximum at 325 nm.

| Elution band | Retention time | Proportion | |
|---|---|---|---|
| no. | (min.) | (% by weight) | Substance |
| 1 | 2.1 | 88.3 | unknown |
| 2 | 2.9 | 5.9 | unknown |
| 3 3b | 3.1; 3.9 | 5.3 | unknown |
| Σ | | 99.5 | |

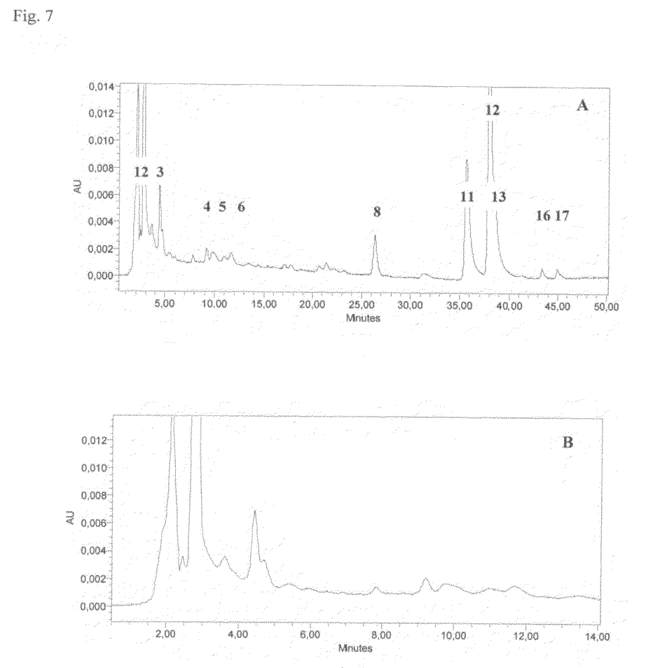

Fraction 2 (see FIG. 7) is obtained in the 2. elution step. By means of the HPLC-chromatography bands 1 to 6, 8, 11 to 13, and 16 to 17 are identified in fraction 2. Fraction 2 contains essentially two substance classes, namely a further, less water soluble proportion (ca. 49.6% by weight) of the α-bitter-acids cohumulone (11), humulone (12), and adhumulone, as well as a smaller proportion of the flavonoids, e.g. xanthohumol (band 8, 3.7% by weight) and isoxanthohumol (band 6, 1.2% by weight). In the bands 16 and 17 the β-bitter-acids colupulone (16) and lupulone+adlupulone (17), 1.8% by weight are detected. Bands 1 to 3 correspond to a proportion of 36.9% by weight and are assigned to non characterised substances. The yellow powder obtained from fraction 2 contains up to 49.6% by weight α-bitter-acids. The essential identification features, particularly the percentage proportions, are illustrated in table 3.

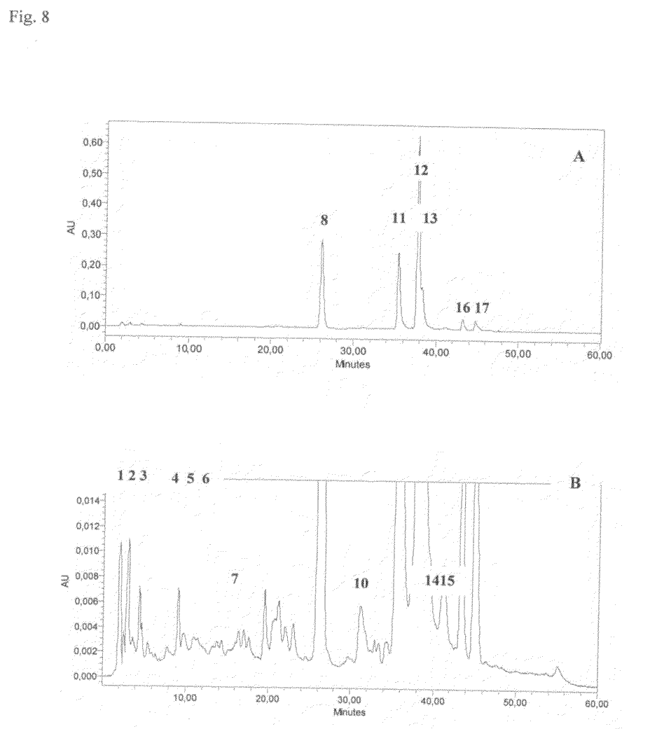

Fraction 3 is a yellow solution and contains the largest proportion of the flavonoids (see FIG. 8), which can be detected in the retention time 9 minutes to 27 minutes. These are e.g. desmethylxanthohumol, dihydroxyanthohumol, particularly the xanthohumol (band 8, 22.7% by weight), as well as substances having phyto-hormonal action and estrogen like acting substances (6- and 8-prenylnaringenin) respectively. By drying a yellow powder is formed. Assignment of the three bands 1, 2, and 3 has not been carried out yet. Band 6 contains isoxanthohumol (1.1% by weight). Also fraction 3 contains in the bands 11, 12, and 13 the α-bitter-acids cohumulone (11), humulone (12) and adhumulone (13) a total amount amounting to 67.5% by weight. In bands 16 and 17 the β-bitter-acids colupulone (16), lupulone+adlupulone (17) are detected, having a total amount amounting to 5.4% by weight. The complexity of the molecular composition of fraction 3 is illustrated in the HPLC-chromatogram of FIG. 8 as band complex 1 to 8, and 10 to 17. The essential identification features, particularly the percentage proportions, are disclosed in Table 4. From the component mixture of fraction 3 measured in the retention time of 5 to 32 minutes, mono-prenylated flavonoids of hops, a hops extract enriched with xanthohumol, particularly xanthohumol—each according to application purpose in pure form or in a form with high purity—(product name: Hopfenflavo natur), hops extract enriched with 6- and/or 8-prenylnaringenin, further 6- and/or 8-prenylnaringenin—each according to application purpose in pure form or in a form with high purity—(product name: Hopfenflavo natur), as well as desmethylxanthohumol, isoxanthohumol and dehydroxanthohumol, either as mono-prenylated and as di-prenylated hops flavonoids.
FIG. 7: Illustration of fraction 2 with the complex bands 1 to 6, 8, 11 to 13, 16 and 17 in the HPLC-chromatogram of the forward-elution, eluted in the second elution stage. Image parts A and B differ in the spreading of the ordinate.

TABLE 3
Identification features of essential components in fraction
2 due to measurements in the absorption maximum at 325 nm.

| Elution band | Retention time | Proportion | |
|---|---|---|---|
| no. | (min.) | (% by weight) | Substance |
| 1 | 2.1 | 14.3 | Unknown |
| 2 | 2.9 | 21.4 | Unknown |
| 3 | 3.1 | 1.2 | Unknown |
| 4 | 7.2 | 0.9 | Unknown |
| 5 | 8.8 | 1.4 | Unknown |
| 6 | 11.2 | 1.2 | Isoxanthohumol |
| 8 | 24.9 | 3.7 | Xanthohumol |
| 11 | 35.2 | 14.2 | Cohumulone |
| 12 | 37.4 | 35.4 | Humulone |
| 13 | 37.9 | — | Adhumulone |
| 16 | 42.6 | 0.6 | Colupulone |
| 17 | 44.1 | 1.2 | Lupulone + Adlupulone |
| Σ | | 95.5 | |

FIG. 8: Illustration of fraction 3 in the HPLC-chromatogram of the forward-elution with the complex bands 1 to 8, and 10 to 17. Fraction 3 is eluted in the third elution stage. Image parts A and B differ by spreading of the ordinate.

TABLE 4
Identification features of essential components of fraction
3 due to measurement in the absorption maximum at 325 nm.

| Elution band | Retention time | Proportion | |
|---|---|---|---|
| no. | (min.) | (% by weight) | Substance |
| 1 | 2.1 | 0.6 | Unknown |
| 2 | 2.9 | 0.1 | Unknown |
| 3 | 3.1 | 0.5 | Unknown |
| 4 | 7.2 | 0.3 | Unknown |
| 5 | 8.8 | 0.1 | Unknown |
| 6 | 11.2 | 0.1 | Isoxanthohumol |
| 7 | 18.5 | 0.4 | Unknown |
| 8 | 24.9 | 22.7 | Xanthohumol |
| 10 | 30.9 | 0.3 | Xanthohumol D |
| 11 | 35.2 | 18.4 | Cohumulone |
| 12 | 37.4 | 40.2 | Humulone |
| 13 | 37.9 | 8.9 | Adhumulone |
| 15 | 40.6 | 0.6 | Unknown |
| 16 | 42.6 | 2.3 | Colupulone |
| 17 | 44.1 | 2.5 | Lupulone + Adlupulone |
| Σ | | 98.0 | |

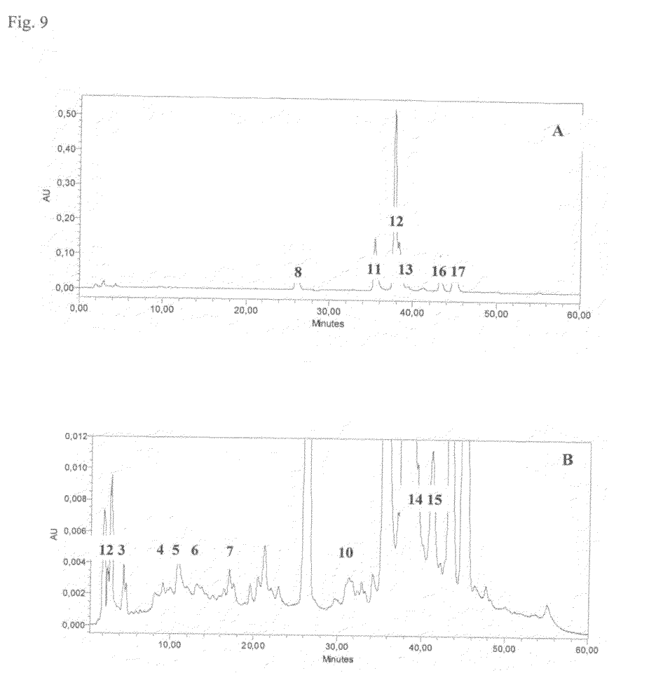

Fraction 4 is a brown-yellow solution, which takes a reddish colour after longer standing under air. After drying a brown-yellow powder is obtained. The solution provides a mixture of the hops bitter-acids (see FIG. 9), namely consisting of the α-bitter-acids cohumulone (11), humulone (12), adhumulone (13), represented by the bands 11 to 13 having 66.9% by weight and by the β-bitter-acids colupulone (16) an lupulone+adlupulone (17) represented by the bands 16 to 17, having 19.2% by weight in largely pure form. Fraction 4 further contains flavonoids, particularly xanthohumol (band 8, 9.8% by weight). The bands in the retention time of 1.5 to 24.0 minutes represent 1.6% by weight. They represent traces of substances occurring also in fractions 2 and 3. The complexity of the molecular composition of fraction 4 is illustrated in the HPLC-chromatogram of FIG. 9 as band complexes 1 to 8, and 10 to 17. The essential identification features, particularly percentage proportions appear in Table 5.
FIG. 9: Illustration of fraction 4 after forward-elution with the complex bands 1 to 8, and 10 to 17 in the HPLC-chromatogram, eluted in the fourth elution stage. Image part A and B differ by the spreading of the ordinate.

The α-bitter-acids and the β-bitter-acids in their mixture can be completely separated under application of known separation methods. In this way bitter-acids can be obtained in pure form and in large amounts for the first time, as well as enriched lupulone-extracts and/or enriched humulone-extracts.

This separation can for example be carried out by means of the known acid-base-separation process. For this purpose under mixing to fraction 4 a 5 to 10% by weight NaOH-solution is added and heated to 50 to 80° C. for 30 to 60 minutes. After cooling the β-bitter-acids are found in the filtrate and the α-bitter-acids in the residue.

TABLE 5
Identification features of essential components of fraction
4 due to measurements at the absorption maximum at 325 nm.

| Elution band | Retention time | Proportion | |
|---|---|---|---|
| no. | (min.) | (% by weight) | Substance |
| 1 | 2.1 | 0.7 | Unknown |
| 2 | 2.9 | 0.2 | Unknown |
| 3 | 3.1 | 0.5 | Unknown |
| 5 | 8.8 | 0.2 | Unknown |
| 8 | 24.9 | 9.8 | Xanthohumol |
| 10 | 30.9 | 0.3 | Xanthohumol D |
| 11 | 35.2 | 13.4 | Cohumulone |
| 12 | 37.4 | 40.7 | Humulone |
| 13 | 37.9 | 12.9 | Adhumulone |
| 14 | 38.9 | 0.4 | Unknown |
| 15 | 40.6 | 1.1 | Unknown |
| 16 | 42.6 | 8.0 | Colupulone |
| 17 | 44.1 | 10.1 | Lupulone + Adlupulone |
| Σ | | 98.3 | |

Particularly, according to application purpose α-bitter-acids can be obtained in pure form or in a form having high purity, as a mixture of α-bitter-acids enriched with humulone, a mixture of β-bitter-acids enriched with lupulone or lupulone in pure form or in a form with high purity. Particularly, the present invention provides the possibility to adjust reproducibly and reliably the humulone content in a mixture with α-bitter-acids or the lupulone content in a mixture with β-bitter-acids.

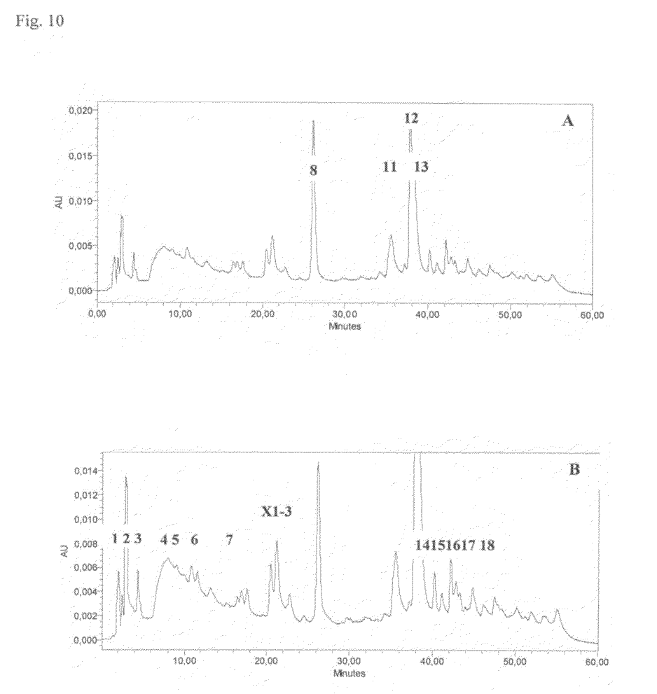

Fraction 5 eluted in the forward-elution contains only all hops ingredients soluble in 90 to 97% by weight ethanol. This fraction is at first coloured green and takes a brown colour after longer standing at room temperature under air. When the solvent is largely removed in the evaporator, a precipitation of a green viscous mass finally occurs. The remaining yellow supernatant and the green residue are separated by decantation.
FIG. 10: HPLC-chromatogram of the yellow supernatant of fraction 5 obtained with the forward-elution. The chromatogram shows a complex image with a larger number of partly overlapping bands 1 to 18 (bands 9 and 10 are negligible). In Table 5 the bands are, as far as is known, assigned to specific substances. Image part A and B differ by the spreading of the ordinate.

The HPLC-chromatogram of the supernatant (see FIG. 10) shows a complex image with a larger number of smaller and greater, partly overlapping bands (1 to 18). The band complex X1-3 is specifically characterised and still not yet assigned. The essential characteristics, particularly the percentage proportions are shown in Table 6.

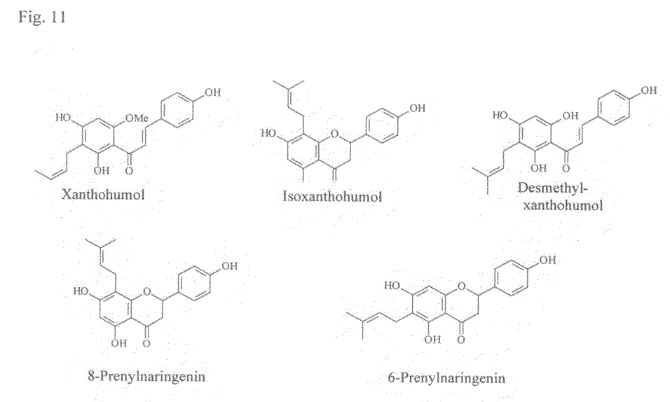

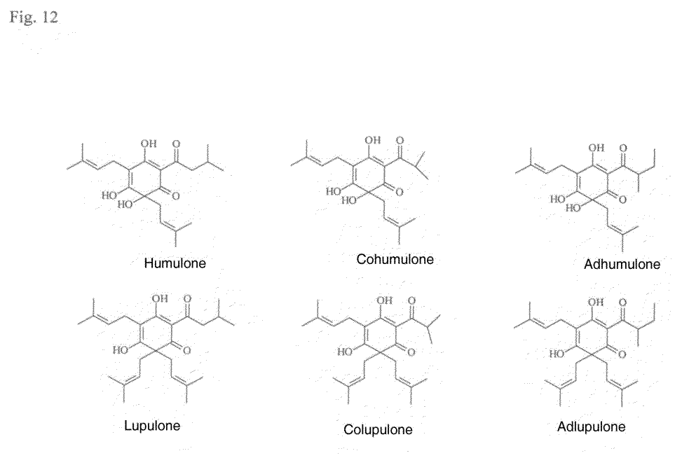

From Table 6 it can be taken, that the supernatant of fraction 5 contains proportions amounting of 8.9% by weight of the hops flavonoids xanthohumol (band 8), amounting of 39.8% by weight of the α-bitter-acids, namely cohumulone (11), humulone (12), adhumulone (13), and contains to the amount of 4.6% by weight of the β-bitter-acids, namely colupulone (16) and lupulone+adlupulone (17). The chemical structures of the Flavonoids are shown in FIG. 11 and that of the hops bitter-acids in FIG. 12.

TABLE 6
Characterisation of the bands (molecular components) of
the supernatant of fraction 5 (identified in the absorption
maximum at 325 nm) resolved in the HPLC-chromatogram.

| Elution band | Retention time | Proportion | |
|---|---|---|---|
| no. | (min.) | (% by weight) | Substance |
| 1 | 2.1 | 3.4 | Unknown |
| 2 | 2.9 | 4.7 | Unknown |
| 3 | 3.1 | 5.7 | Unknown |
| 4 | 7.2 | 10.7 | Unknown |
| 5 | 8.8 | 1.2 | Unknown |
| 6 | 11.2 | 1.6 | Isoxanthohumol |
| 7 | 18.5 | 1.2 | Unknown |
| 8 | 24.9 | 8.9 | Xanthohumol |
| 11 | 35.2 | 6.5 | Cohumulone |
| 12 | 37.4 | 17.1 | Humulone |
| 13 | 37.9 | 16.2 | Adhumulone |
| 14 | 38.9 | 1.8 | Unknown |
| 15 | 40.6 | 0.8 | Unknown |
| 16 | 42.6 | 2.7 | Colupulone |
| 17 | 44.1 | 1.1 | Lupulone + Adlupulone |
| 18 | 45.3 | 1.0 | Unknown |
| 19 | 46.4 | 1.1 | Unknown |
| X1-3 | 20-23 | 9.3 | Iso-α-bitter-acids |
| Σ | | 95.0 | |

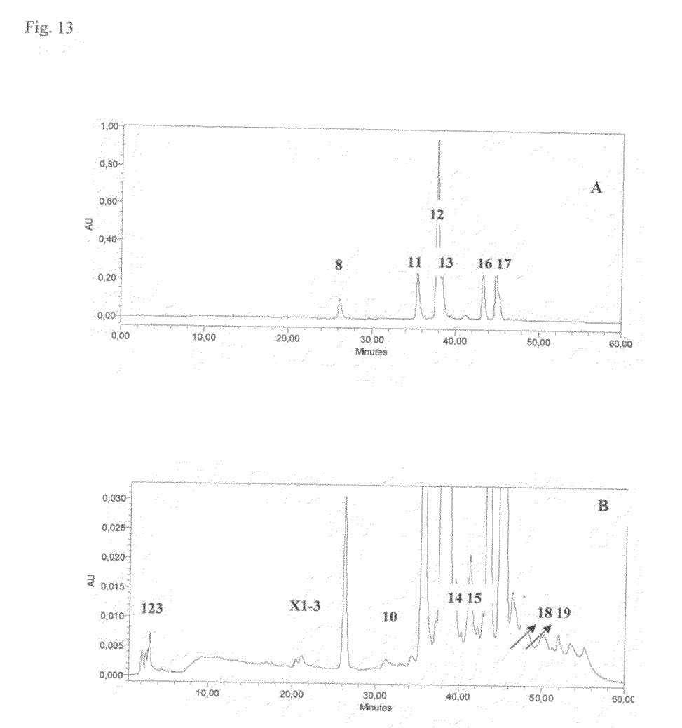

FIG. 11: Chemical structures of hops flavonoids, xanthohumol (band 8) and isoxanthohumol (band 6) can be isolated in a relatively large amount from the supernatant of fraction 5.
FIG. 12: Chemical structures of hops bitter-acids. Humulone (band 12), cohumulone (band 11), and adhumulone (band 13) belonging to the α-bitter-acids, and co-lupulone (band 16) and lupulone+adlupulone (band 17), belonging to the β-bitter-acids, can be isolated in larger amounts from the supernatant of fraction 5.
FIG. 13: HPLC-chromatogram of the residue with bands 8 as well 10 to 19 obtained from fraction 5 after forward-elution. Image parts A and B differ by the spreading of the ordinate.

In the HPLC-chromatogram of the brown residue band 8 represents xanthohumol, constituting (see FIG. 13) 2.0% by weight of the residue. Bands 11 to 13 are the α-bitter-acids cohumulone (11), humulone (12), and adhumulone (13) having a total proportion of 52.7% by weight. Bands 15 to 17 can be assigned to the β-bitter-acids colupulone (16) and lupulone+adlupulone (18) with a total proportion of 35% by weight.

TABLE 7
Characterisation of the dissolved bands (molecular
components) of the residues (measured at the adsorption
maximum of 325 nm) obtained after forward-elution
of fraction 5 in the HPLC chromatogram.

| Elution band | Retention time | Proportion | |
|---|---|---|---|
| no. | (min.) | (% by weight) | Substance |
| 1 | 2.1 | 0.2 | Unknown |
| 2 | 2.9 | 0.1 | Unknown |
| 3 | 3.1 | 0.3 | Unknown |
| 8 | 24.9 | 2.0 | Xanthohumol |
| 10 | 30.9 | 0.1 | Xanthohumol D |
| 11 | 35.2 | 9.3 | Cohumulone |
| 12 | 37.4 | 32.6 | Humulone |
| 13 | 37.9 | 10.8 | Adhumulone |
| 14 | 38.9 | 1.1 | Unknown |
| 15 | 40.6 | 2.3 | Unknown |
| 16 | 42.6 | 12.1 | Colupulone |
| 17 | 44.1 | 20.6 | Lupulone + Adlupulone |
| 18 | 45.3 | 1.5 | Unknown |
| 19 | 46.4 | 1.3 | Unknown |
| X1-3 | 20-23 | 0.2 | Iso-α-bitter-acids |
| Σ | | 93.2 | |

The essential characteristics, particularly the percentage proportions, are illustrated in Table 7. The hops ingredients, particularly the mono- and di-prenylated hops flavonoids, which bands occur in the time interval of 8 to 24 minutes of the HPLC-chromatogram, are practically not detectable. In fraction 5 the elution bands 8 to 18 (measured at 325 nm) are therefore of sole critical significance.

In the forward-elution of fraction 5 the product “Hopfenbitter pur” (see following chapter) is obtained as bands 8-18. This product corresponds fraction 5 (bands 8-18), which is obtained from the backward-elution.

Description of fractions 5 to 1 after backward-elution and detection of the ingredients occurring within the fractions:

Fractions 5 to 1, obtained by means of the above described backward-elution, show in specific limits a relative constant and reproducible composition of their molecular components.

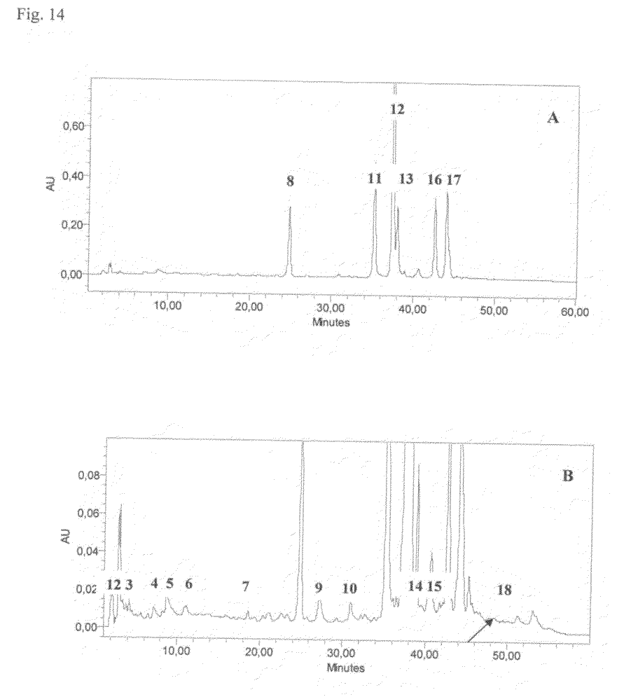

Fraction 5 contains all hops ingredients dissolved in 90-97% of ethanol also at least 18 components (see FIG. 14). The bands resolved in the HPLC-chromatogram are numbered according to the increasing elution times from 1 to 18. After backward-elution the elution bands 11 to 18 (measured at 325 nm) of fraction 5 have due to their amount a prominent significance. The essential identification features, particularly the percentage proportions are illustrated in Table 8.

The different products can be classified according to the retention intervals: In the time interval of 22 to 33 minutes bands 8, 9, and 10 occur. In these three bands xanthohumol (8) and xanthohumol D (9) turn up. The substance of band 10 is not yet identified.

In the time interval between 33 and 55 minutes the α-bitter-acids cohumulone (11), humulone (12), adhumulone (13), pre-humulone and post-humulone can be detected. The β-bitter-acids colupulone (16), lupulone+adlupulone (17), pre-lupulone and post-lupulone occur in the time segment of bands 15 to 17. Bands 14 and 18 are not yet assigned to substances.
FIG. 14: Illustration of fraction 5 after backward-elution in the HPLC-chromatogram. Dissolvable molecular components are measured at wavelength of 325 nm and characterised by the numbers 1 to 18. Image parts A and B differ in the spreading of the ordinate.

Fraction 5 is a green-brown coloured, viscous solution. Is the solvent largely removed a green-brown mass of viscous consistence is obtained. Thus, fraction 5 provides in its totality product “Hopfenbitter natur”. When bands 11 to 18 are separated from the remaining components by fractionation the product “Hopfenbitter pur” is obtained. After fractionation band 8 forms the product “Hopfen-pharma”.

Fraction 5 (Hopfenbitter natur), consisting of the mixture of all components 1 to 18 (see Table 8), demonstrates a product that is corresponding to the German purity law and can be added to beer as watery, alcoholic or after thickening as viscous solution or be used as active agent and additive, respectively in the cosmetic and food industry.
Table 8: Identification features of the essential components of fraction 5 after backward-elution due to adsorption measurements at maximum at 325 nm.

TABLE 8
Identification features of the essential components
of fraction 5 after backward-elution due to adsorption
measurements at maximum at 325 nm.

| Elution band | Retention time | Proportion | |
|---|---|---|---|
| no. | (min.) | (% by weight) | Substance |
| 1 | 2.1 | 0.5 | Unknown |
| 2 | 2.9 | 0.6 | Unknown |
| 3 | 3.1 | 0.5 | Unknown |
| 4 | 7.2 | 0.5 | Unknown |
| 5 | 8.8 | 1.1 | Unknown |
| 6 | 11.2 | 0.2 | Isoxanthohumol |
| 7 | 18.5 | 0.2 | Unknown |
| 8 | 24.9 | 8.7 | Xanthohumol |
| 9 | 26.9 | 0.1 | Unknown |
| 10 | 30.9 | 0.4 | Xanthohumol D |
| 11 | 35.2 | 14.0 | Cohumulone |
| 12 | 37.4 | 37.0 | Humulone |
| 13 | 37.9 | 9.1 | Adhumulone |
| 14 | 38.9 | 0.7 | Unknown |
| 15 | 40.6 | 1.6 | Unknown |
| 16 | 42.6 | 9.5 | Colupulone |
| 17 | 44.1 | 12.7 | Lupulone + Adlupulone |
| 18 | 45.3 | 0.1 | Unknown |
| Σ | | 97.4 | |

The product obtained by means of fraction 5 contains almost all hops ingredients, particularly, a proportion of up to 60.1% of α-bitter-acids (see table 8, bands 11 to 13). Fraction 5 can therefore be used under the reference “Hopfenbitter natur” as ethanol-extract of hops, which corresponds to the German purity law.

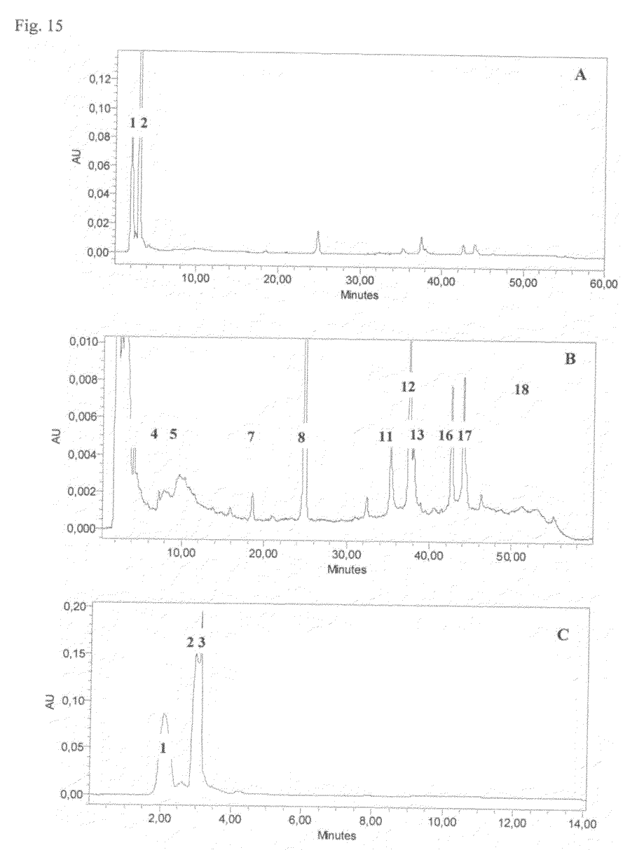

Compared to fraction 5, obtained from backward-elution, fraction 5 obtained as residue from forward-elution results in a complete or largely separation of the substances 6-prenylnaringenin and 8-prenylnaringenin occurring in hops. The substances lastly named are suspected and it has been proven already regarding these substances, respectively, that they have an estrogen effect in humans. In case of 8-prenylnaringenin this effect is similar to that of 17β-estradiol. To definitely avoid undesired or unhealthy effects with the consumers, there is thus an urgent need for products of hops basis from which the hormone like ingredients have been removed completely or partly. This requirement does not only apply for beers or brewery products, but also for hops product containing food, cosmetics and pharmaceuticals. This requirement is met by use of “Hopfenbitter pur”.
FIG. 15: Illustration of fraction 4 after backward-elution in the HPLC-chromatogram. The dissolvable molecular components are measured at wavelength of 325 nm and characterised by the numbers 1 to 8, 11 to 13, 16 to 18. Image parts A and B differ by the spreading of the ordinate.

Fraction 4, obtained by backward-elution, contains the hops bitter-acids in the mixture in very small amounts, namely the α-bitter-acids cohumulone (11), humulone (12), adhumulone (13), pre-humulone and post-humulone as well as the β-bitter-acids colupulone (16), lupulone+adlupulone (17), pre-lupulone and post-lupulone. Additionally, fraction 4 contains flavonoids in small amounts, particularly xanthohumol (8). In this fraction the elution bands 1 to 3 (measured at 325 nm) can, however, be determined with the largest weight in the time interval between 1 and 6 minutes.

The essential identification features, particularly the percentage proportions are illustrated in Table 9. The components separated in the HPLC-chromatogram are numbered from 1 to 18 as in fraction 5 according to the increasing elution time. In this chromatogram the bands 6, 9, 10, 14, and 15 are practically not detectable at 325 nm.

TABLE 9
Illustration of the identification features of
the essential components of fraction 4 due to measurements
in the adsorption maximum at 325 nm.

| Elution band | Retention time | Proportion | |
|---|---|---|---|
| no. | (min.) | (% by weight) | Substance |
| 1 | 2.1 | 30.0 | Unknown |
| 2 | 2.9 | 28.7 | Unknown |
| 3 | 3.1 | 20.2 | Unknown |
| 4 | 7.2 | 0.1 | Unknown |
| 7 | 18.5 | 0.4 | Unknown |
| 8 | 24.9 | 5.0 | Xanthohumol |
| 9 | 26.9 | 0.1 | Unknown |
| 11 | 35.2 | 1.3 | Cohumulone |
| 12 | 37.4 | 3.9 | Humulone |
| 13 | 37.9 | 1.0 | Adhumulone |
| 16 | 42.6 | 1.8 | Colupulone |
| 17 | 44.1 | 1.3 | Lupulone + Adlupulone |
| 18 | 45.3 | 0.1 | Unknown |
| Σ | | 93.9 | |

Bands 1, 2, and 3, occurring in fraction 4 after backward-elution, account for a proportion amounting 78.8%. On the other side fraction 4, obtained by forward-elution, shows a complete and largely separation, respectively of substances 6-prenylnaringenin and 8-prenylnaringenin occurring in hops. Additionally, a large amount amounting to 86.2% of hops-bitter-acids is detected, amounting to 67.0% of α-bitter-acids and amounting to 19.2% of β-bitter-acids. The residue of fraction 4 corresponds to the residue of fraction 5 and is therefore combined. Thus product “Hopfenbitter pur” is obtained. The filtrate of the fraction 5 and the fraction 4, obtained from the forward-elution, is combined with fraction 3, obtained from the forward-elution.

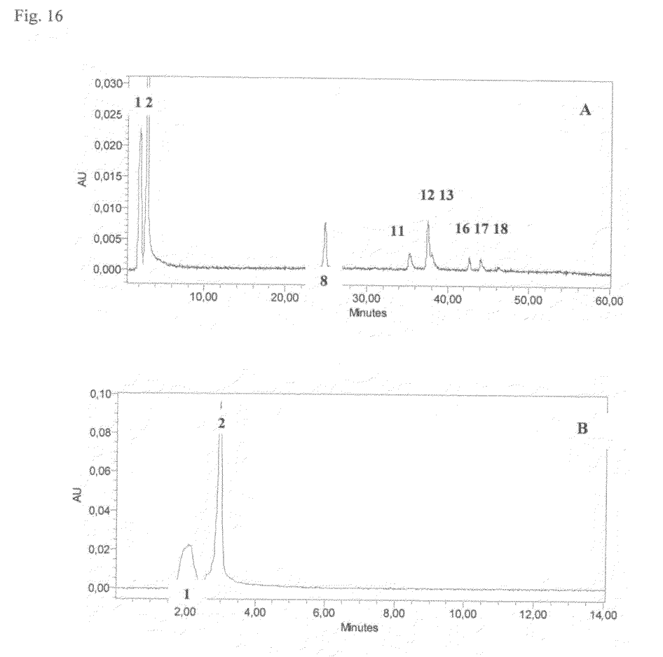

Fraction 3, obtained by backward-elution, is not identical or comparable to fraction 3 obtained by forward-elution. It contains scilicetly essentially the bands 1 and 2 having a proportion of 80.6% by weight (see FIG. 16 and Table 10). These two bands are, however, not assigned to specifically characterised substances (see Table 10). Bands 3 to 6 and 7 are not detectable in fraction 3 after backward-elution. Band 8 contains the flavonoid xanthohumol. Moreover, fraction 3 contains α-bitter-acids cohumulone (11), humulone (12), adhumulone (13) as well as β-bitter-acids colupulone (16), and lupulone+adlupulone (17) (see Table 10). Fraction 3 is a yellow coloured solution and foams heavily when removing the solvent. Practically, a complete solvent removal (rotary evaporator) is impossible. After complete removal of solvent by means of freeze-drying a brown coloured solid is obtained.
FIG. 16: Illustration of fraction 3 in the HPLC-chromatogram after backward-elution. The molecular components are measured at wavelength of 325 nm and characterised by the numbers 1, 2, 8, 11 to 13 and 16 to 18. A and B differ by the spreading of the ordinate.

TABLE 10
Identification features of essential molecular components in fraction
3 due to measurements in the adsorption maximum at 325 nm.

| Elution band | Retention time | Proportion | |
|---|---|---|---|
| no. | (min.) | (% by weight) | Substance |
| 1 | 2.1 | 29.1 | Unknown |
| 2 | 2.9 | 51.4 | Unknown |
| 8 | 24.9 | 1.4 | Xanthohumol |
| 11 | 35.2 | 2.0 | Cohumulone |
| 12 | 37.4 | 6.6 | Humulone |
| 13 | 37.9 | 1.0 | Adhumulone |
| 16 | 42.6 | 2.5 | Colupulone |
| 17 | 44.1 | 3.0 | Lupulone + Adlupulone |
| Σ | | 97.0 | |

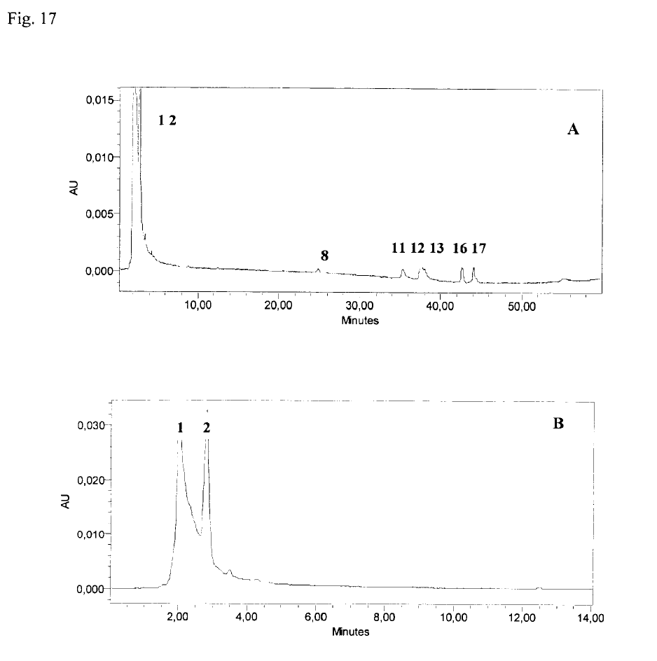

Fraction 2, obtained in the backward-elution step, shows bands 1, 2, 8, 11 to 13, 16 and 17 (see FIG. 17) in the HPLC-chromatogram. In this fraction 2 the essential hardly water soluble proportions of the α-bitter-acids cohumulone (11), humulone (12), and adhumulone (13), as well as the β-bitter-acids colupulone (16) and lupulone+adlupulone (17) can be detected.

Further a smaller portion of the flavonoid xanthohumol (8) is identified. The major bands 1 and 2 are molecularly not yet assigned and characterised. The percentage proportion of bands 1, 2, 8, 11 to 13, 16 and 17 are illustrated in Table 11.

FIG. 17: Illustration of fraction 2 in the HPLC-chromatogram after backward-elution. The dissolvable molecular components are measured at wavelength of 325 nm and characterised by the numbers 1, 2, 8, 11 to 13, and 16 and 17. Image parts A and B differ by the spreading of the ordinate.

TABLE 11
Identification features of essential components of
fraction 2 after backward-elution on the basis of
measurements in the adsorption maximum at 325 nm.

| Elution band | Retention time | Proportion | |
|---|---|---|---|
| no. | (min.) | (% by weight) | Substance |
| 1 | 2.1 | 59.7 | Unknown |
| 2 | 2.9 | 31.4 | Unknown |
| 11 | 35.2 | 2.6 | Cohumulone |
| 12 | 37.4 | 2.1 | Humulone |
| 16 | 42.6 | 1.6 | Colupulone |
| 17 | 44.1 | 1.1 | Lupulone + Adlupulone |
| Σ | | 98.5 | |

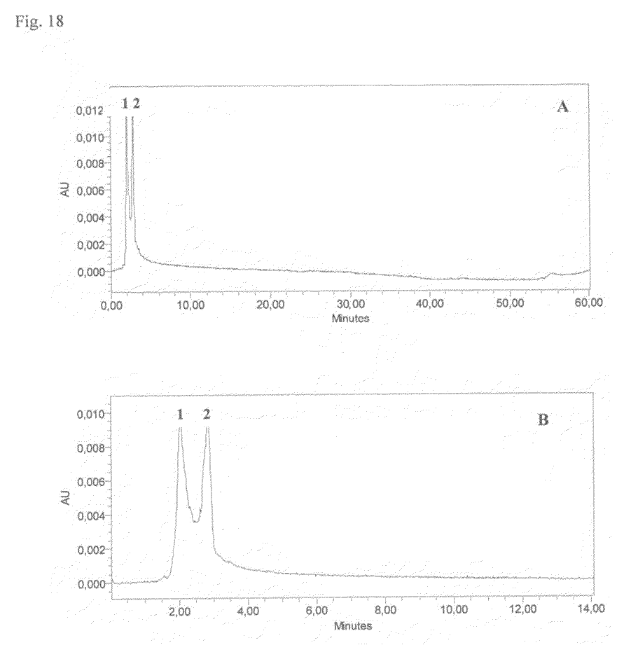

Fraction 1 (see FIG. 18) eluted with pure water in the backward-elution shows in the HPLC-chromatogram at least two bands, namely bands 1 and 2. Band 1 corresponds to a proportion of 57.0% by weight, band 2 corresponds to a proportion of 43.0% by weight in fraction 1 (see table 12).
FIG. 18: Illustration of fraction 1 in the HPLC-chromatogram after backward-elution. At least two molecular components (bands 1 and 2) are measured at wavelength of 325 nm. Image A and B differ by the spreading of the ordinate.

TABLE 12
Identification features of essential components of fraction
1 due to measurements in the adsorption maximum at 325 nm.

| Elution band | Retention time | Proportion | |
|---|---|---|---|
| no. | (min.) | (% by weight) | Substance |
| 1 | 2.1 | 56.96 | Unknown |
| 2 | 2.9 | 43.04 | Unknown |
| Σ | | 100.00 | |

A comparison of fraction 1 to 5 under the sole consideration of bands 1 to 3 after forward- and backward-elution:

In the following chapter (see table 13) fractions 1 to 5 eluted in the forward- and backward-elution are compared with each other under sole consideration of bands 1 to 3. Fractions 1 to 5 and 5 to 1, respectively, obtained both in the forward-elution and in the backward-elution can be obtained in a very cost-effective method and with relative little effort as pre-products or as one, two, three or more products.

TABLE 13
Comparison of fractions 1 to 5 and 5 to 1, respectively
after forward-elution and backward-elution, respectively
under the sole consideration of bands 1, 2, and 3 occurring
in the time interval of 1 to 6 minutes.

| | Forward-elution | | Backward-elution |
|---|---|---|---|
| Fraction no. | (% by weight) | Fraction no. | (% by weight) |
| 1 | VL: 93.0 | 1 | 2.1 |
| | NL: 99.5 | | |
| 2 | 37.8 | 2 | 78.8 |
| 3 | 1.5 | 3 | 80.5 |
| 4 | ÜS: 11.5 | 4 | 91.1 |
| | RS: 0.2 | | |
| 5 | RS: 0.7 | 5 | 100 |
| | ÜS: 14.9 | | |

VL, forerun; NL, back-run; ÜS, supernatant; RS residue

The great advantage of both above described elution methods resides in a practically complete separation of the bands 1, 2, and 3, being not yet assigned to a molecular entity, from the other already clearly identified hops ingredients. The effect of these substances is also not yet known in detail. In fraction 1 of the forward-elution and in fraction 5 of the backward-elution bands 1 to 3 can be obtained in pure form and can be well separated from the remaining hops ingredients.

Fractions 4, 3, 2, and 1 obtained by backward-elution (see Table 13) provide also the possibility to completely separate bands 1 to 3 from the remaining hops ingredients. After separation of bands 1 to 3 the eluates can again be applied to hops-self-cellulose and can be post-purified or subjected to a specific chromatography, to obtain products having different compositions of the hops ingredients.

Separation of Hops Ingredients Precipitated from their Solvents by Means of Hops Self-Cellulose:

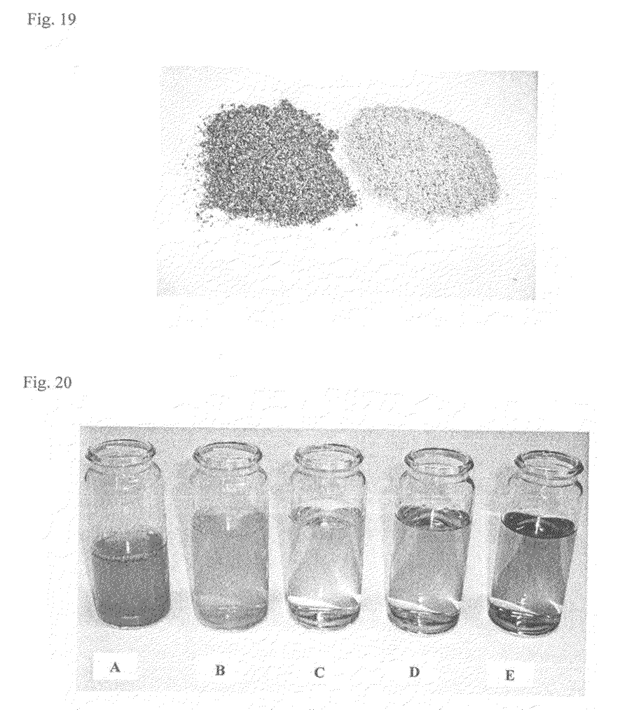

After application of the above described, inventive methods the hops ingredients eluted in the known fractions are re-precipitated and applied onto the already purified hops self-cellulose. Also other substances eluted from natural material can be re-suspended in a water/alcohol mixture and applied to purified hops-self-cellulose. After application the inventive elution steps are carried out. By means of this method it is demonstrated that the self-cellulose is suitable as stationary phase for elution and for separation of any substances from vegetal raw material.
FIG. 19: Colour comparison between the milled hops as dry material (left) and the purified, dried hops-self-cellulose (right).

The preparation of purified hops-self-cellulose as stationary phase is carried out in proceeding the already above described elution steps. After eluting all hops ingredients the hops-self-cellulose remains (see FIG. 19) in the eluator (B).

Dependent from the applied elution method the purified hops-self-cellulose remains, which is suspended at the end of the elution method in ethanol and water, respectively. The hops ingredients are suspended for example in water or in alcohol/water mixtures, bound to the hops-self-cellulose and subsequently stepwise eluted by forward-elution, as described. In case of the backward-elution the hops ingredients and hops-self-cellulose are to be suspended in ethanol.

Provision (receiver, respectively) of purified hops-self-cellulose, production of the extracts to be separated on the self-cellulose, application of the extract onto the surface of the purified self-cellulose and performance of the elution steps are described by means of an example. At first 0.2 kg of purified hops-self-cellulose as powder are filled into the elution vessel (B) and supported on a 4 litre suction filter pore 3. By repeatedly applying a vacuum the material is densified (B1). Subsequently, a hops extract is generated in such a manner, that 0.2 kg hops of cultivar Taurus (harvest vintage 2005) of the hops refinement organisation is powdered with a cutting mill. Afterwards the powder is extracted with 70 to 96% ethanol during mixing for 24 hours. The extract is concentrated to 100 ml volume and subsequently diluted with water to 1.000 ml. A concentrated extract results, namely the solution L1. This extract L1 is slowly applied onto the prepared purified self-cellulose (B1). Once the extract entered completely in the surface of the self-cellulose the 1. stage of the elution of the hops-extracts on self-cellulose is carried out with pure water (drinking water quality) by means of solvent LM1. LM1 is directed through the self-cellulose of hops as long as all water soluble ingredients are completely removed from the self-cellulose (see FIG. 6).
FIG. 20: Illustration of the colour of fractions 1 (A), 2 (B), 3 (C), 4 (D), and 5 (E) after stage-elution.

Performance of the second elution step is carried out by solvent LM2, consisting of an ethanol/water mixture having a content of 20 to 40% by volume, preferably with a content of 25 to 35% by volume, particularly with a content of 30% by volume ethanol. By elution with LM2 fraction 2 (see FIG. 7) is obtained as yellow solution.

Subsequently elution with a third solvent mixture LM3 is following, consisting of an ethanol/water mixture having a proportion of 40 to 70% by volume, preferably 45 to 60% by volume, particularly 45 to 55% by volume ethanol. Fraction 3 is a yellow solution (see FIG. 8).

In a fourth elution process fraction 4 (see FIG. 9), having a green-yellow colour (see FIG. 20 D) is eluted under application of solvent mixture LM4 consisting of an ethanol/water mixture having a proportion of 70 to 90% by volume, preferably 75 to 85% by volume and particularly 80 to 85% by volume ethanol.

Subsequently a further elution of the extraction good can be carried out with an ethanol/water mixture LM5, containing 90 to 96% by volume, preferably 94 to 96% by volume, and particularly 96% by volume ethanol. Fraction 5 (see FIG. 9), having a green colour (see FIG. 20E) is obtained.

Chromatographic Separation of Fractions 1 to 5 Obtained after Forward-Elution on Purified Hops Self-Cellulose:

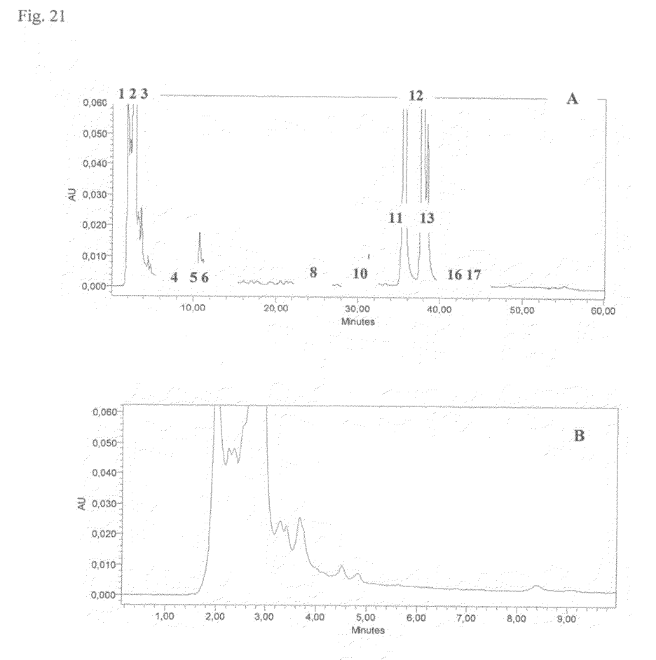

Bands 1 to 6, 8, 10, 11 to 13, and 16 and 17 are identified (see FIG. 21) in fraction 1 by means of HPLC-chromatography. Fraction 1 contains essentially two substance classes, namely a further, less water soluble portion (ca. 51.8% by weight) of the α-bitter-acids cohumulone (11), humulone (12), and adhumulone (13), as well as a smaller proportion of flavonoids e.g. xanthohumol (band 8; 0.1% by weight) and isoxanthohumol (band 6: 0.7% by weight).

Bands 5 and 10 represent a proportion of 1.7 and 1.5% by weight are assigned to substances not yet characterised. In bands 16 and 17 the β-bitter-acids colupulone (16), lupulone+adlupulone (17) are detected with a proportion of 0.5% by weight. Bands 1 to 3 correspond to a proportion of 36.0% by weight and are to be assigned to substances not yet characterised. The essential identification features, particularly the percentage proportion, are illustrated in Table 14. Since hops-self-cellulose is used as stationary phase fraction 1 obtained by this method should correspond regarding the percentage composition of its ingredients to the composition of the fraction obtained from the forward-elution. This is, however, not the case. The percentage composition of the ingredients of fraction 1 eluted from the self-cellulose is similar rather to the percentage composition of the ingredients of fraction 2, obtained with the natural forward-elution. Possibly the basic extract is not completely freed from ethanol.
FIG. 21: Illustration of fraction 1 in the HPLC-chromatogram after binding to the hops-self-cellulose and forward-elution therefrom. The molecular components are measured at wavelength 325 nm and characterised by the numbers 1 to 6, 8, 11 to 13, 16 and 17. Image A and B differ by the spreading of the ordinate.

TABLE 14
Illustration of the identification features of essential components
of fraction 1, obtained on self-cellulose in the forward-elution,
due to measurements in the adsorption maximum at 325 nm.

| Elution band | Retention time | Proportion | |
|---|---|---|---|
| no. | (min.) | (% by weight) | Substance |
| 1 | 2.1 | 5.8 | Unknown |
| 2 | 2.9 | 27.7 | Unknown |
| 3 | 3.1 | 2.5 | Unknown |
| 4 | 7.2 | 0.1 | Unknown |
| 5 | 8.5 | 1.7 | Unknown |
| 6 | 11.2 | 0.7 | Isoxanthohumol |
| 8 | 24.9 | 0.1 | Xanthohumol |
| 10 | 26.9 | 1.5 | Unknown |
| 11 | 35.2 | 22.8 | Cohumulone |
| 12 | 37.4 | 23.3 | Humulone |
| 13 | 37.9 | 5.7 | Adhumulone |
| 16 | 42.6 | 0.3 | Colupulone |
| 17 | 44.1 | 0.2 | Lupulone + Adlupulone |
| Σ | | 92.4 | |

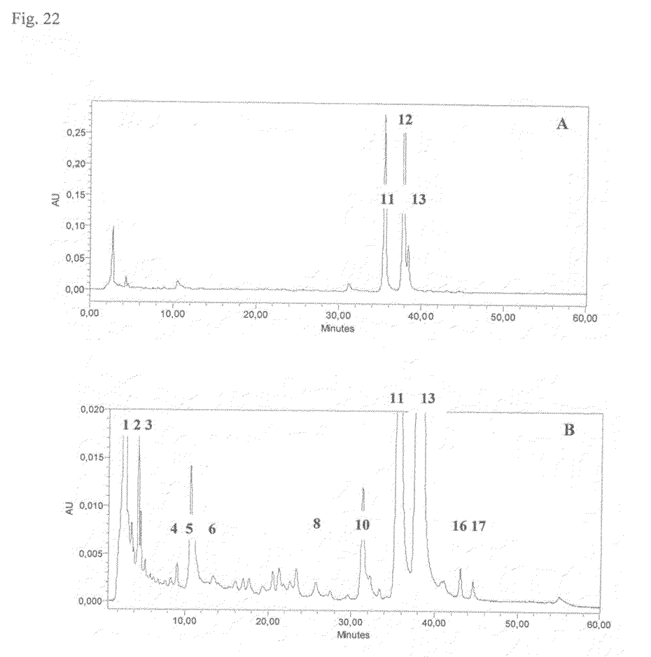

Fraction 2 obtained after forward-elution of the hops material from the already purified hops-self-cellulose is comparable with fraction 2, obtained by natural forward-elution. It scilicetly contains essentially the α-bitter-acids cohumulone (11), humulone (12), adhumulone (13) with a proportion of 81.1% by weight, as well as the β-bitter-acids colupulone (16) and lupulone+adlupulone (17) having a proportion of 0.5% by weight (see FIG. 22 and Table 15). Additionally, fraction 2 contains bands 1, 2, and 3 having a proportion of 13.5% by weight. These bands are, however, not assigned to specifically characterised substances. Bands 4 to 6 are detectable in fraction 2 with a proportion of 1.3% by weight. Band 8 contains the flavonoid xanthohumol.
FIG. 22: Illustration of fraction 2 (after elution from the self-cellulose) in the HPLC-chromatogram after binding to the hops-self-cellulose and forward-elution therefrom. The molecular components are measured at wavelength of 325 nm and characterised by the numbers 1 to 6, 8, 10, 11 to 13, 16 and 17. Image part A and B differ by the spreading of the ordinate.

TABLE 15
Illustration of the identification features of essential components
of fraction 2, obtained on self-cellulose in the forward-elution,
due to measurements in the adsorption maximum at 325 nm.

| Elution band | Retention time | Proportion | |
|---|---|---|---|
| no. | (min.) | (% by weight) | Substance |
| 1 | 2.1 | 11.5 | Unknown |
| 2 | 2.9 | 0.7 | Unknown |
| 3 | 3.1 | 1.3 | Unknown |
| 4 | 7.2 | 0.1 | Unknown |
| 5 | 8.5 | 0.2 | Unknown |
| 6 | 11.2 | 1.0 | Isoxanthohumol |
| 7 | 18.5 | 0.1 | Unknown |
| 8 | 24.9 | 0.1 | Xanthohumol |
| 10 | 26.9 | 1.4 | Unknown |
| 11 | 35.2 | 32.6 | Cohumulone |
| 12 | 37.4 | 39.7 | Humulone |
| 13 | 37.9 | 8.8 | Adhumulone |
| 16 | 42.6 | 0.3 | Colupulone |
| 17 | 44.1 | 0.2 | Lupulone + Adlupulone |
| Σ | | 98.0 | |

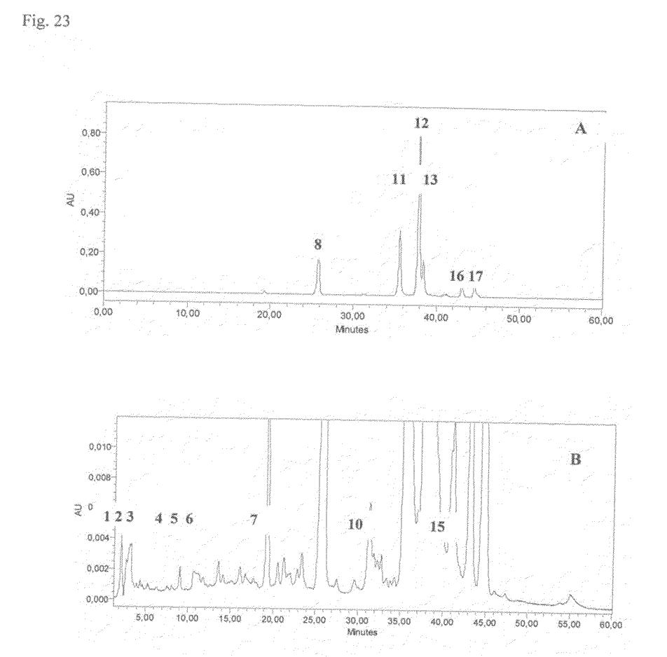

Fraction 3, obtained by elution from the already purified hops-self-cellulose, is comparable to fraction 3, obtained by natural forward-elution. In both cases fraction 3 provides a mixture of hops bitter-acids (see FIG. 23 and Table 16) consisting of the α-bitter-acids cohumulone (11), humulone (12), adhumulone (13) with a proportion of 75.4% by weight and of the β-bitter-acids colupulone (16) and lupulone+adlupulone (17) having a proportion of 8.9% by weight. The single fractions can be obtained in a largely pure form. Furthermore, fraction 3 contains flavonoids, particularly xanthohumol (band 8, 13.3% by weight). The bands appearing in the retention time of 1.5 to 24.0 minutes represent 0.8% by weight. They represent traces of the substances occurring also in fractions 1 and 2.

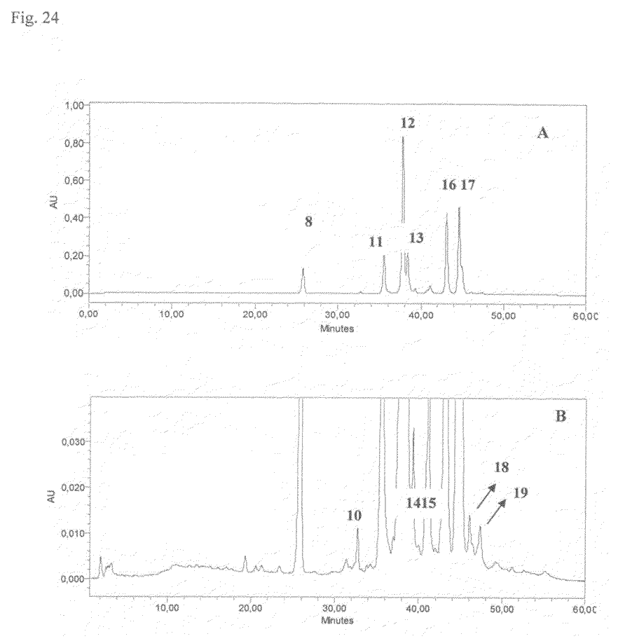

In the HPLC-chromatogram of fraction 4 the band 8 represents the xanthohumol, providing 5.3% by weight of fraction 4 (see FIG. 24 and Table 17). Bands 11 to 13 are to be assigned to the α-bitter-acids cohumulone (11), humulone (12), and adhumulone (13) having a total proportion of 51.2% by weight. Bands 16 and 17 can be assigned to the β-bitter-acids colupulone (16) and lupulone+adlupulone (17) having a total content of 32.8% by weight. The essential characteristics, particularly the percentage proportion, are illustrated in Table 17. The hops ingredients, particularly the mono- and diprenylated flavonoids of hops, the bands of which occur in the time interval of 8 to 24 minutes of the HPLC-chromatogram, are practically not detectable. In fraction 4 the elution bands 8, 10 to 19 (measured at 325 nm) are alone of critical significance.
FIG. 23: Illustration of fraction 3 in the HPLC-chromatogram after binding to the hops-self-cellulose and forward-elution therefrom. The molecular components are measured at wavelength 325 nm and characterised by the numbers 1 to 7, 8, 10, 11 to 13, 15 and 17. Image A and B differ by the spreading of the ordinate.

TABLE 16
Illustration of the identification features of essential components
of fraction 3, obtained on self-cellulose in the forward-elution,
due to measurements in the adsorption maximum at 325 nm.

| Elution band | Retention time | Proportion | |
|---|---|---|---|
| no. | (min.) | (% by weight) | Substance |
| 1 | 2.1 | 0.2 | Unknown |
| 2 | 2.9 | 0.2 | Unknown |
| 3 | 3.1 | 0.1 | Unknown |
| 4 | 7.2 | 0.1 | Unknown |
| 5 | 8.5 | 0.1 | Unknown |
| 6 | 11.2 | 0.1 | Isoxanthohumol |
| 7 | 18.5 | 0.8 | Unknown |
| 8 | 24.9 | 13.3 | Xanthohumol |
| 10 | 26.9 | 0.3 | Unknown |
| 11 | 35.2 | 18.9 | Cohumulone |
| 12 | 37.4 | 45.6 | Humulone |
| 13 | 37.9 | 10.9 | Adhumulone |
| 15 | 40.8 | 0.6 | Unknown |
| 16 | 42.6 | 4.0 | Colupulone |
| 17 | 44.1 | 3.9 | Lupulone + Adlupulone |
| Σ | | 99.1 | |

FIG. 24: Illustration of fraction 4 in the HPLC-chromatogram after binding to after forward-elution of the hops-self-cellulose. The molecular components are measured at wavelength of 325 nm and characterised by the numbers 7 to 8, 10 to 18. Image parts A and B differ by the spreading of the ordinate.

TABLE 17
Illustration of the identification features of essential components
of fraction 4, obtained in the forward-elution on self-cellulose,
due to measurement in the adsorption maximum at 325 nm.

| Elution band | Retention time | Proportion | |
|---|---|---|---|
| no. | (min.) | (% by weight) | Substance |
| 8 | 24.9 | 5.3 | Xanthohumol |
| 10 | 26.9 | 0.3 | Unknown |
| 11 | 35.2 | 8.2 | Cohumulone |
| 12 | 37.4 | 34.0 | Humulone |
| 13 | 37.9 | 9.0 | Adhumulone |
| 14 | 38.9 | 1.1 | Unknown |
| 15 | 40.8 | 2.3 | Unknown |
| 16 | 42.6 | 15.8 | Colupulone |
| 17 | 44.1 | 17.0 | Lupulone + Adlupulone |
| 18 | 45.0 | 4.5 | Unknown |
| 19 | 47.0 | 0.4 | Unknown |
| Σ | | 97.9 | |

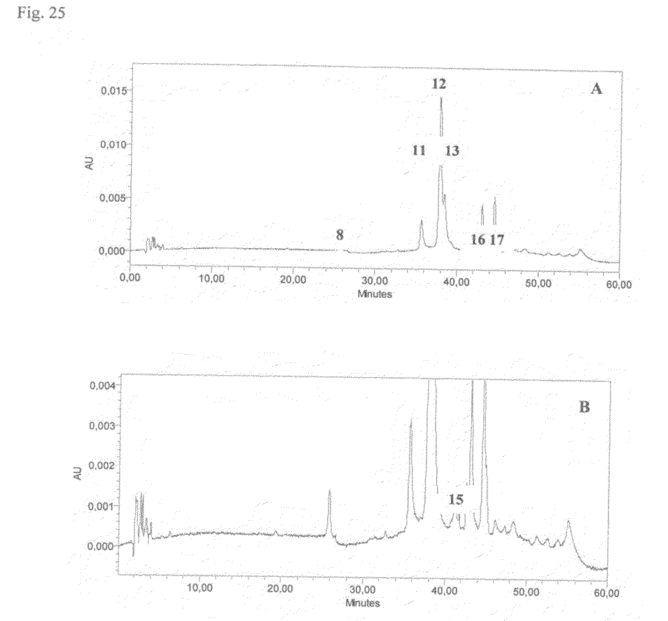

FIG. 25: Illustration of fraction 5 in the HPLC-chromatogram after binding to hops-self-cellulose and after forward-elution therefrom. The molecular components are measured at wavelength of 325 nm and are characterised by numbers 8, 11 to 13 and 15 to 17. Image parts A and B differ in the spreading of the coordinate.

Regarding the number and the percentage proportions of the ingredients fraction 4 is comparable to the residue of fraction 5, obtained by forward-elution. The residue of fraction 5 scilicetly provides the product “Hopfenbitter pur”, containing the bands 8 and 10 to 18. This product corresponds at the same time to fraction 5, obtained with bands 8 to 18 by backward-elution.

Regarding to its molecular components fraction 5 which is obtained by elution after binding to the suitable hops-self-cellulose is comparable with the residue, obtained from fraction 5 (see FIG. 13 and Table 7) by forward-elution. Fraction 5 scilicetly contains essentially the α-bitter-acids cohumulone (11), humulone (12), and adhumulone (13) having a proportion of 69.2% by weight, as well as the β-bitter-acids colupulone (16) and lupulone+adlupulone (17) having a proportion of 23.6% by weight (see FIG. 25 and Table 18). Band 8 contains the flavonoid xanthohumol (corresponding 2.3% by weight).

TABLE 18
Illustration of the identification features of essential components
of fraction 5 after forward-elution on purified self-cellulose
by measurement of the adsorption in the maximum at 325 nm.

| Elution band | Retention time | Proportion | |
|---|---|---|---|
| no. | (min.) | (% by weight) | Substance |
| 8 | 24.9 | 2.3 | Xanthohumol |
| 11 | 35.2 | 8.5 | Cohumulone |
| 12 | 37.4 | 41.8 | Humulone |
| 13 | 37.9 | 18.9 | Adhumulone |
| 15 | 40.9 | 1.8 | Unknown |
| 16 | 42.6 | 9.0 | Colupulone |
| 17 | 44.1 | 14.6 | Lupulone + Adlupulone |
| Σ | | 96.9 | |

From the residues of fraction 4 (see bands 8, 10-18) and fraction 5 (see bands 8, 10-19) the product “Hopfenbitter pur” is obtained. This product is also obtained from fraction 5 (bands 8-18), eluted by the backward-elution.

Products to be Derived from the Fractions and Possible Examples of Application:

The invention is now illustrated by means of several examples. It should not be limited in its application range of substances by the description of examples. The fractions 1 to 5 described above can be enriched with or depleted of regarding their ingredients, if desired. Specific ingredients can be isolated with a specific purity or with desired composition from fractions 1 to 5 to add these subsequently in a controlled way in case of application. Different methods known to the skilled person can be applied for this extensive enrichment and depletion, respectively, for example chromatographic purification methods.

The above described inventive methods provide particularly the advantage that a complete or also partly separation of the substances 6-prenylnaringenin and 8-prenylnaringenin occurring in hops is possible. Both mentioned separated substances are suspected respectively of which are proven that they have hormone like effects in humans. The effect of these substances corresponds to the effect of the female sex hormones of the group of the estrogens. In case of 8-prenylnaringenin it has been specifically determined that its effect is very similar to that of 17β-estradiol. To definitely avoid undesired or unhealthy effects on the consumers it is desired to provide pre-products on hops basis from which these undesired ingredients are completely or partly removed. This requirement is not only of great significance for the production of beer or brewery products but also for the generation of hops product containing foods, cosmetics and pharmaceuticals.

This above described objective is achieved by application of the inventive extraction method, comprising the aforesaid mentioned elution step 3, wherein the substances 6-prenylnaringenin and 8-prenylnaringenin are separated by applying elution step 3. A hops extract freed from 6-prenylnaringenin and 8-prenylnaringenin can already be obtained by that, that the extracts which are combined are obtained in an at least one further (preceding and/or succeeding) stage elution step, wherein optimally also a hops extract of fraction 3 freed from 6-prenylnaringenin and/or 8-prenylnaringenin by means of common methods known to the skilled person can be added.

Therefore, the present invention particularly aims also to an extraction of a phyto-hormone free or phyto-hormone depleted mixture of hops ingredients, preferably a mixture of hops ingredients, free of 6-prenylnaringenin and/or 8-prenylnaringenin or depleted of regarding 6-prenylnaringenin and/or 8-prenylnaringenin, for the production of beverages and brewery products, particularly beer.

In this way the present invention allows in an always reproducible manner the extraction of a hops extract freed completely from 6-prenylnaringenin and 8-prenylnaringenin or depleted of to a great extend regarding these substances. Here, in the present invention the term “depleted of to a great extend regarding a substance” means, that a substance to be depleted is merely present in a content accounting for less than 50%, preferably less than 10%, preferably less than 1% of the original content of this substance in dry weight. The term “enriched with regarding a substance” (“enriched on a substance”) means that the substance is present at a content exceeding the starting concentration of the substance in dry weight by more than 10%, preferably more than 50%, preferably more than 100%.

The present invention further allows that in performing of only one elution step an extract is obtained which contains only the water soluble hops ingredients, particularly the tanning agents. This purpose is achieved, when the extraction good is extracted with water in a first step and the thus obtained hops extract is collected.

The present invention describes generally a method which surprisingly allows a separation or enrichment of specific natural material, particularly flavonoids in a very easy, but most effective manner. Moreover, the inventive method provides the advantage that the demand of solvent is kept low. Further, it opens great prospects for an automation of the elution method.

Particularly, the present invention allows the extraction of a substance mixture or a single substance, selected from the substance class consisting of xanthohumol, hops extract depleted of xanthohumol, hops extract enriched with xanthohumol, 6-prenylnaringenin, hops extract depleted of 6-prenylnaringenin, hops extract enriched with 6-prenylnaringenin, 8-prenylnaringenin, hops extract depleted of 8-prenylnaringenin, hops extract enriched with 8-prenylnaringenin, adlupulone, hops extract depleted of adlupulone, hops extract enriched with adlupulone, colupulone, hops extract depleted of colupulone, hops extract enriched with colupulone, lupulone, hops extract depleted of lupulone, hops extract enriched with lupulone, humulone, hops extract depleted of humulone, hops extract enriched with humulone, adhumulone, hops extract depleted of adhumulone, hops extract enriched with adhumulone, cohumulone, hops extract depleted of cohumulone, hops extract enriched with cohumulone, α-bitter-acid mixtures, hops extract depleted of α-bitter-acids, hops extract enriched with α-bitter-acids, β-bitter-acid mixtures, hops extract depleted of β-bitter-acids, hops extract enriched with β-bitter-acids, and mixtures thereof.

In this connection specific hops ingredients can be obtained in pure form or in a form having high purity (for example having a purity of 85% or more, preferably 90% or more, preferably of 97% or more). Moreover, with the present invention mixtures of α-bitter-acids can be obtained in pure form or in a form having high purity, a mixture of α-bitter-acids enriched with humulone, a mixture of β-bitter-acids enriched with lupulone or humulone or lupulone in pure form or in a form having high purity.

The present invention comprises the above mentioned substances and substance mixtures. The term hops extract can refer either to the solvent containing hops extract and also to the substance mixture (substance) obtained therefrom after drying.

These hops materials or substance mixtures of hops ingredients can be used for numerous applications. A particular important application is e.g. the use of one or more of the aforesaid mentioned hops ingredients or one of the subsequently mentioned enriched or depleted substance mixtures of hops ingredients for implementation of a sleep supporting and/or sedative effect. Preferably, α-bitter-acid mixtures, hops extracts depleted of α-bitter-acid, hops extracts enriched with α-bitter-acid, β-bitter-acid mixtures, hops extracts depleted of β-bitter-acid, hops extracts enriched with β-bitter-acid, and mixtures thereof are applied. Such an extract can for example facilitate falling asleep, but also extend the sleep phases of a person. Particularly, it is intended for application in human and mammal. The required amount of one or more hops ingredients or in substance mixtures enriched with or depleted of one or more hops ingredients can be selected by a skilled person on the basis of his general knowledge. Preferably, such an extract can be completely free of 6-prenylnaringenin and 8-prenylnaringenin or it contains less than 0.005 to 5% by weight, preferably less than 0.003 to 3% by weight of the 6-prenylnaringenin and/or 8-prenylnaringenin referred to the total dry weight of the hops material.

Preferably, such an extract is suitable for oral intake. For specific applications the formulation of the mixtures can for example be carried out in form of tablets, capsules or in a fluidic administration form. Administration can for example also be carried out orally, by i.v. and i.m. injection, respectively or nasal by spray, by inhalation, vaginally, anally, topically or in another administration form known to the skilled person. Such a formulation can for example contain a dose of a specific hops ingredient or of a mixture of hops ingredients in the range of 0.001 g to 10 g, wherein such a formulation can be taken once or several times a day. Optional the mixture can contain further active agents and appropriate formulation additives known to the skilled person.

Furthermore, one of the aforesaid mentioned hops ingredients or one of the aforesaid mentioned substance mixtures from hops ingredients can be applied for the production of a medicament for the treatment and/or prevention of diseases, caused by a bacterial infection, e.g. with staphylococci, particularly with staphylococci having multiple antibiotic resistances. Treatment and/or prevention of diseases caused by an infection of e.g. with helicobacter pylori is also conceivable. In this connection, α-bitter-acid mixtures, hops extracts depleted of α-bitter-acid, hops extracts enriched with α-bitter-acid, β-bitter-acid mixtures, hops extracts depleted of β-bitter-acid, hops extracts enriched with β-bitter-acid and mixtures thereof are preferably used. Preferably, such a medicament is free of 6-prenylnaringenin and/or 8-prenylnaringenin or is contains less than 5% by weight of the 6-prenylnaringenin and/or 8-prenylnaringenin, preferably less than 3% by weight of the 6-prenylnaringenin and/or 8-prenylnaringenin, each referred to the dry weight of the hops material.

Moreover, the mentioned hops ingredients or one of the aforesaid mentioned substance mixtures of the hops ingredients can be used as preservative. Particular suitable is the application as a preservative for food and cosmetic products which is accepted by the consumers to a high degree. In this connection, α-bitter-acid mixtures, hops extracts depleted of α-bitter-acid, hops extracts enriched with α-bitter-acid, β-bitter-acid mixtures, hops extracts depleted of β-bitter-acid, hops extracts enriched with β-bitter-acid and mixtures thereof are preferably used. In this process the products to be preserved can be added for example between 0.001 and 40% by weight, preferably between 0.005 and 2% by weight of the hops material or of their mixtures, referred to the weight of the product to be preserved. Moreover, the hops ingredients or mixtures of the hops ingredients can also be used as a mixture with one or more further inorganic and/or organic preservatives.

Moreover, the mentioned hops ingredients or one of the aforesaid mentioned substance mixtures of the hops ingredients can be used as pesticide, particularly as insecticide. In this connection α-bitter-acid mixtures, hops extracts depleted of α-bitter-acid, hops extracts enriched with α-bitter-acid, β-bitter-acid mixtures, hops extracts depleted of β-bitter-acid, hops extracts enriched with β-bitter-acid and mixtures thereof are preferably used. The specific formulation of the pesticide is carried out according to the knowledge of the skilled person. Particularly, the pesticide or insecticide formulation can comprise further substances or substance mixtures, having a pesticide or insecticide action.

### Economic Advantages of the Elution Method:

The described invention (stage elution as forward and as backward-elution) differs from already known chromatographic methods therein, that the patent to be patented is preferably used, when very large amounts of pre-products from plants or vegetal basic materials are to be extracted (obtained, respectively) in an as natural as possible way (extraction by means of ethanol/water mixtures) at room temperature and the application of hitherto known chromatographic methods and chromatographic gradient methods for cost reasons, capacity reasons or reasons of process time are not or economically not possible.

Moreover, by utilising the naturally conspicuous (precipitating, respectively) vegetal self-cellulose considerable cost advantages are achieved compared to commercially available cell substance materials (as stationary phase). Particularly, it is possible, that from one or more fractions one or more undesired substances are separated by means of the described method and the such processed or purified fractions are combined with other extraction fractions to obtain an extract which is freed from specific undesired, for example unhealthy substances.

In this connection it is of high significance that the eluted fractions or combinations of the same substances or substance mixtures obtained can be characterised by positive interactions. On the other side it is possible to deplete or separate substances to an increased extend having negative function.

The present invention is highly advantageous because of its cost-effectiveness, convenience of performance, extraction of large amounts and selective extraction of substances or substance mixtures. The advantages of the described methods reside in that, that not only a chromatographic separation and extraction of substance classes or substance groups is possible in large amounts (in technical scale) on the self-cellulose, but that by directing through the mobile phase there is always provided fresh, i.e. largely “unloaded” solvent at the stationary phase, which is “loaded” by and by first when passing the stationary phase, such that an exhausting extraction of the extraction good is largely ensured.

Such a method should utilise a comparable low amount of the organic solvents (alcohol) and thus have the advantage that it at least enables a selective enrichment or isolation of specific vegetal ingredients from a natural material in separation methods as is intended in the present invention in an easy and economic way.

The invention incidentally refers to a new method for isolating of, for example, nutritional physiologically, cosmetic, pharmaceutical or otherwise significant substances in form of substance groups or in pure from by elution from plants (hops) or plant products (hops products) with watery/alcoholic solvents on the vegetal self-cellulose as stationary phase.

Specific advantages of the invention described here reside in the outstanding procedural simplicity such that the investments required for implementation of the method are relative low. Moreover, the method requires relative low energy consumption, since each kind of heating during the extraction is omitted. The method is suitable for selective extraction of vegetal ingredients according to substance classes under normal conditions, what, for example with hops, allows the selective extraction of alpha-acids, beta-acids, tanning agents, flavonoids and other polyphenols.

The advantage of the method described here resides in that not only a chromatography like separation and extraction of substance classes or substance groups in large amounts (technical scale) is possible by the binding to the self-cellulose, but that in directing through the mobile phase always fresh, largely “unloaded” solvent is present at the stationary phase. At first, in passing the stationary phase the mobile phase is “loaded” by and by, such that an exhaustive extraction of the extraction good is largely ensured. The vegetal extraction good is added discontinuously to solvent and the leached out extraction good is separated from the solvents containing the vegetal ingredients by applying the common extraction methods. This process provides more or less marked the totality of the vegetal ingredients. In contrast to the conventional extraction methods the material components are successively separately dissolved from the extraction good by the method described here i.e. by a permanent elution process with alternating solvents and/or solvent mixtures of differing composition. The method thereby can be controlled dependent from on the one hand desired and on the other hand possibly disturbing ingredients in such a way that for example the disturbing ingredients are dissolved with a first solvent or solvent mixture before the extraction of the actual interesting ingredients starts and vice versa, respectively.

The method particularly enables the extraction of a phyto-hormone free hops extract which incidentally contains all remaining hops ingredients in naturally amounts, such that that can be used in the brewery industry according to the German purity law. The substances having phyto-hormone and estrogenous action (6- and 8-prenylnaringenin), respectively are eluted e.g. in the forward-elution by means of LM3 in fraction 3. From fraction 3 the phyto-hormonal substances can be completely removed by common laboratory methods, for example, VLC (vacuum liquid chromatography). Partly or completely depleted flavonoid-extracts and the remaining hops extracts obtained by the method can be combined according to the requirements of the German brewers (purity law).

### Markets and Potential of the Hops Ingredients Obtained by the Inventive Method:

If desired the extracted fractions of the above mentioned steps can be further enriched with or depleted of regarding specific ingredients. The ingredients can, however, also be obtained therefrom in a purity, which is appropriate for the respectively desired applications. For this purpose different known methods, like chromatographic purification methods can be used.

In case of fraction 1 an extraction of tanning agents, sugar containing compounds, hops bitter-acids and other water soluble hops ingredients is carried out. This fraction has a fruity aroma. It has e.g. a sedative effect.

In case of fraction 2 α-bitter-acids are extracted from hops, which are used for example as foaming and bittering agents in the beer branch. Fraction 2 contains components, being said to have an effect against staphylococci and against multiple antibiotic resistances (MRS). This fraction can also be applied against helicobacter pylori. The use as antibiotic and antibiotic component, respectively in a pharmaceutical formulation is therefore basically possible. This fraction 2 can be applied as a pesticide or as anti-oxidative, preservative or as anti bacterial product in the branches of foods, cosmetics and pharmaceuticals.

With fraction 3 flavonoids, for example xanthohumol, are obtained. Where appropriate, flavonoids in enriched or flavonoids in pure form or in a form with high purity can be obtained by means of the following common laboratory methods, for example VLC (vacuum liquid chromatography). In in-vitro experiments xanthohumol is said to have shown a preventive effect for example against osteoporosis, arteriosclerosis, diseases of the coronary vessels, heart attack and stroke. At the same time a high anti cancerous potential has been proven. Xanthohumol shows a growth inhibiting and cytotoxic effect directed against 60 different human tumour-cell lines, such as in case of leukaemia, lung cancer, cancer of the large intestine, melanoma, breast cancer, etc. In tests with isolated mouse mammary gland cells (MMOC-test, mouse mammary gland organ culture) xanthohumol revealed to be more than 200-fold effective than resveratrol isolated from red vine. In all hitherto described in-vitro experiments no cytotoxic effect has been proven against healthy cells [Lit.: Tabata et al., (1997), To be et al., (1997), Miranda et al., (1999, 2000), Stevens et al., 1998), Henderson et al., (2000), Gerhauser et al., (2002)]. By means of in-vivo experiments on rats the metabolism, bio-availability and pharmacokinetics of the substances could be elucidated. In these experiments xanthohumol showed no toxic effect (dose: 1.000 mg xanthohumol per kg body weight of the animal). For this reason xanthohumol, hops extract depleted of xanthohumol or hops extract enriched with xanthohumol could because of its food supplementing characteristics and moreover, because of its considerable pharmacologic potential be successfully implemented in health supporting and age inhibiting products in the branches of food supplements/health food, cosmetic, pharmaceutical. At the same time the inventive method enables a complete or partly separation of the substances 6-prenylnaringenin and 8-prenylnaringenin (hops phyto-hormones) occurring in hops, being substances suspected and being proven, respectively, to act hormone like in humans. The effect is similar to that of female sex hormones from the group of estrogens. It has been proven specifically in the case of 8-prenylnaringenin that it has a similar effect as 17β-estradiol. To avoid definitely undesired or unhealthy effects in the consumers there is the request for products on hops basis from which these ingredients have been completely or partly removed. This requirement is not only of significance for beers or brewery products but also for hops product containing cosmetics and pharmaceuticals. The hops phyto-hormone 8-prenylnaringenin is the hitherto most active phyto-hormone having an estrogen effect.

In case of fraction 4 pure bitter-acids (mixture of α- and β-bitter-acids) are obtained. Fraction 4 can be separated by known methods, wherein pure bitter-acids and enriched lupulone-extracts, respectively and/or enriched humulone-extracts are obtained. Particularly, this purification can for example be carried out by an extraction from the mixture of a watery phase at acidic, neutral or basic pH-values, for example by an acid-base separation process into an organic phase. The hops extract obtained from fraction 4 and/or the substances contained therein, particularly, the bitter-acids, are characterised by sedative and sleep supporting characteristics and can be used for the production of sedative or sleep supporting products and medicaments, respectively. The components of fraction 4, for example, the hops bitter-acids humulone, adhumulone, cohumulone, pre-humulone and post-humulone, the hops extracts depleted of the respective bitter-acid, the hops extracts enriched with the respective bitter-acid, as well as the bitter-acids lupulone, adlupulone, colupulone, pre-lupulone and post-lupulone, the hops extracts depleted of the respective bitter-acid and hops extracts enriched with respective bitter-acid act as preservative for the use in the branch of foods, cosmetics and pharmaceuticals. The β-bitter-acids show for example an activity against staphylococcus aureus, Listeria monocytogenes, lactobacillus helveticus, multiple resistant staphylococci strains (MRS), acne causing microbes as well as against helicobacter pylori and can be applied as pesticides.

In fraction 5 chlorophylls and further water insoluble or in a mixture of water and ethanol having an ethanol content of less than 90% insoluble hops ingredients are collected. This fraction can also used as natural green dye in the branches of foods, cosmetics and pharmaceuticals.

### Stage-Extraction

The basic material (5 kg hops umbel) is finely crushed with an Alpin-Rotoplex cutting mill of type RO 20/10 B, wherein the pieces obtain a maximal size of 1 mm³. Subsequently, the crushed basic material is filled in an extraction barrel (company Ecker Hydro-Anlagen GmbH) and extracted in four stages at room temperature (20° C.) as follows:
A. Extraction with 25 litres of water
B. Extraction with 25 litres of an ethanol/water mixture having an ethanol content of 30% by volume of ethanol
C. Extraction with 20 litres of an ethanol/water mixture having an ethanol content of 50% by volume of ethanol
D. Extraction with 30 litres of an ethanol/water mixture having an ethanol content of 80% by volume of ethanol
E. Extraction with 15 litres of an ethanol/water mixture having an ethanol content of 96% by volume of ethanol.

In this connection an extraction with water removes tanning and sugar agents, as well as a portion of the α-bitter-acids, particularly pre- and post-humulone. The α-bitter-acids humulone, cohumulone and adhumulone are obtained in the extract by an extraction with a solvent mixture according to stage B, while all or essentially all flavonoids in the extract are obtained by extraction with a solvent mixture according to stage C, particularly xanthohumol. It is to be noted in this connection that the polyvinyl pyrrolidone (PVPP-) gel applied in the filtration process almost quantitatively retains flavonoids and particularly, xanthohumol. Therefore, with conventional filtration processes a xanthohumol donation can be carried out not until after filtration. By extraction with a solvent mixture according to stage D a small part of α-bitter-acids and all or essentially all β-bitter-acids, so also particularly lupulone, adlupulone and cohumulone are obtained in the extract. By an extraction with a solvent mixture according to stage E chlorophylls and lipids, as well as other substances are obtained being not soluble in the solvent mixtures previously applied.

If desired the above described extraction fractions (A to E) of the stage extraction can according to the common knowledge be subjected to further processing stages, for example a VLC (vacuum liquid chromatography) and selective products can be obtained in enriched or extract form. Alternatively, the stage extraction enables the fractionation of the hops ingredients in classes and groups, respectively with consistent solubility behaviour.

Analogously to the above described stage extraction a stage extraction can be carried out starting from customary hops pellets (for example hops pellets of company HHV-Hallertauer Hopfenveredelungsgesellschaft, Mainburg or hops pellets of company NATECO₂, Wolnzach) or alcoholic or carbon dioxide extracts of hops or residues of alcoholic or carbon dioxide extracts of hops.

### Extraction of an Estrogen Free Hops Extract

This example describes the extraction of an estrogen free hops extract, which however comprises all remaining hops ingredients, which are desirable for the respective use, for example in the brewery industry.

The substances having phyto-hormonal effect and the estrogen like effective substances (6- and 8-prenylnaringenin), respectively are obtained by an extraction with a solvent mixture according to stage C. From the thus obtained flavonoid extract phyto-hormonal substances (6- and 8-prenylnagingenin) are removed by common laboratory methods, for example VLC (vacuum liquid chromatography) and the partly or completely depleted flavonoid-extract and the other obtained hops extracts (stage A, B, D, E) are combined.

Extraction of Hops—Extracts Enriched with Flavonoids

By means of an extraction with a solvent mixture according to stage B, as described in example 1, specific flavonoids can be enriched. Particularly, a xanthohumol/xanthohumol rich hops extract, a hops extract enriched with 6- and/or 8-prenylnaringenin, hops bitter extract enriched with lupulone and humulone can be produced.

### Extraction of Pure Hops Ingredients

From extracts according to stage A to E of the above example 1 pure hops ingredients can be obtained. Particularly, according to application purpose xanthohumol can be obtained in pure form or in a form with high purity, as described in example 3. Furthermore, 6- and 8-prenylnaringenin can be obtained according to application purpose in pure form or in a form with high purity, as described in example 2. Moreover, the α-bitter-acids can be obtained in an analogous way according to the knowledge of the skilled person in pure form or in a form with high purity, a mixture of α-bitter-acids enriched with humulone, a mixture of β-bitter-acids enriched with lupulone or humulone in pure form or in a form with high purity. Particularly, the present invention provides the possibility to reproducibly and reliably set the humulone content in a mixture of α-bitter-acids or the lupulone content in a mixture of β-bitter-acids.

### Effect of PVPP-Gel on the Xanthohumol Content

An ethanolic stock solution of xanthohumol has been mixed, wherein 1 g of the stock solution contained 19.13 mg xanthohumol.

100 ml beer (beer sort: Bière Blonde de luxe, Brasserie de Saverne/France, alcohol content 4.5%) have been mixed with 32.8 mg stock solution, corresponding to a xanthohumol concentration of 6.3 mg pro litre beer.

The beer sample has been sucked from a column filled with PVPP-gel. The solution having passed the gel has subsequently been subjected to a concentration until dryness on the rotation evaporator and the residue to a HPLC. Comparison of the chromatograms with the reference chromatogram for pure xanthohumol shows, that at the most traces of xanthohumol have passed the PVPP-column (results not shown).

The PVPP-gel has been eluted with an eluent and subsequently the eluent was removed. The HPLC-chromatogram of the residue shows a distinct xanthohumol signal at a retention time of 3.8 minutes.

Brew (Gyle, Respectively) Experiments with Different Hops Extracts and Addition of Xanthohumol and 8-Prenylnaringenin, Respectively to Beer

The extracts Hopsteiner ethanol and CO₂ extract, respectively (conventional extracts) and HOP RE (inventive extract with all natural ingredients) and HOP R5R (inventive extract depleted of 8-prenylnaringenin) have been scrutinised regarding their composition.

At first the different extracts have been analysed for their content of α- and β-bitter-acids by HPLC. The results are illustrated in Table 19.

TABLE 19
Analysis of hops-extracts

| | Hopst. | Hopst. | HOP | HOP |
|---|---|---|---|---|
| Parameter | EtOH | CO₂ | RE | R5R |
| Co-humulone [ppm] | 9.23 | 12.02 | 8.61 | 5.19 |
| n-/ad-humulone [ppm] | 28.95 | 38.40 | 26.24 | 15.85 |
| Σ α-acids [ppm] | 38.18 | 50.42 | 34.85 | 21.04 |
| Colupulone [ppm] | 7.43 | 9.11 | 6.61 | 8.00 |
| n-/ad-lupulone [ppm] | 8.24 | 9.88 | 7.09 | 8.75 |
| Σ β-acids [ppm] | 15.67 | 18.99 | 13.70 | 16.75 |

On the basis of the determined contents of α-acids the dosage of the different brews was carried out later with a target value of 35 bitter units in the single beers.

In the following four 150 L-brews using the different hops extracts have been brewed with an original-wort content between 11 and 11.5%. For assessing the flavour quality and the bittering agent utilisation the most important parameters have been analytically been determined. In Table 20 the results of the flavour analysis is summarised.

TABLE 20
Flavour analysis

| | Hopst. | Hopst. | HOP | HOP |
|---|---|---|---|---|
| Parameter | EtOH | CO₂ | RE | R5R |
| Original-wort [%] | 11.34 | 11.31 | 11.28 | 11.27 |
| Bitter units [BU] | 56 | 63 | 54 | 76 |
| Co-humulone [ppm] | 1.08 | 1.36 | 1.25 | 1.62 |
| n-/ad-humulone [ppm] | 2.28 | 2.93 | 2.48 | 2.15 |
| Σ α-acids [ppm] | 3.36 | 4.29 | 3.73 | 3.77 |
| Co-Isohumulone [ppm] | 1.97 | 2.48 | 2.05 | 2.37 |
| n-Isohumulone [ppm] | 4.65 | 5.13 | 4.12 | 4.65 |
| Ad-Isohumulone [ppm] | 11.33 | 13.03 | 11.95 | 15.30 |
| Σ iso-α-acids [ppm] | 17.95 | 20.64 | 18.13 | 22.32 |
| Xanthohumol [ppm] | 0.7 | 0.6 | 0.9 | 1.6 |
| 8-Prenylnaringenin [ppm] | n.n. | n.n | n.n. | n.n. |
| pH | 5.62 | 5.74 | 5.72 | 5.63 |
| Colour [EBC] | 8.8 | 7.9 | 7.5 | 8.2 |
| Total nitrogen [mg/l] | 866 | 878 | 891 | 864 |
| Coagul. nitrogen [mg/l] | 20 | 17 | 19 | 17 |
| MgSO₄-nitrogen [mg/l] | 197 | 192 | 204 | 191 |
| Polyphenols [mg/l] | 152 | 136 | 115 | 132 |
| Anthcyanogens [mg/l] | 36 | 34 | 34 | 34 |
| Clouding 20° C. | 2.5 | 1.7 | 1.7 | 1.8 |

When glancing on the bitter units a good correlation between Hopsteiner ethanol and HOP RE is shown with the worts (flavours, respectively), correlating with the comparable values for the iso-α-acids, providing the main contribution for the bittere (bitter, respectively). Accordingly, the bitter value of the Hopsteiner CO₂ is still higher. With HOPS R5R a very high bitter value has been measured, also the contents of the single bitter components are clearly higher. Because of a same procedure in the production of the brews a varying bittering agent utilisation can not be assumed. Conventionally, the α-contents represent ⅓ of the bittering agents expressed by the bitter value. This ratio is in all brews almost given. The 8-prenylnaringenin is only detectable in the wort, in which the substance has been added as pure substance. The pH of the Hopsteiner CO₂ and HOP RE is slightly above the conventional range. The values of the colour are typical for the flavour of a pale (full)beer. The nitrogen compounds are of further significance. While the amino acids represent the most important N-sources for the yeast metabolism and via this have a significant influence on the formation of fermentation side products, the medium and high molecular N-compounds are of significance mainly for the colloidal stability, being full-bodied, and foam durability. Thus, besides the measurement of the total nitrogen which lie in the normal range for all flavours, the coagulatable amount (being full-bodied, foam and protein stability) and the MgSO₄-precipitable amount (foam durability) have been determined. Both nitrogen proportions for pale (full)beer worts lie in the normal range and vary only minimally corresponding to the comparable extract contents (original wort). The phenolic compounds according to the structure and molecular size have strong influence on different beer characteristics like colour, taste, foam, as well as the chemical physical stability (clouding formation). The content of the polyphenols influences the colour according to the measured value. The antho-cyanogens have influence on the formation of colloidal cloudings in beer and are thus of particular interest. According to the increased phenol content with Hopsteiner EtOH its antho-cyanogen content is also a little higher. Both the total polyphenols content and the content of antho-cyanogens lies in the lower range of normal contents for (full)beer worts. The worts are to be classified as very clear by clouding values of 2. The worts have been fermented under the same conditions and after filling (conducting away) been stored and filtered. After carbonising has been applied the partly filling into bottles was carried out. A part of the brew HOP R5R has been doted with xanthohumol (target concentration: 5.6 mg/l; R5R+Xn) another part with 8-prenylnaringenin (target concentration 2.5 mg/l; R5R+8PN). The results of the analysis of the bottled beer are summarised in Table 21.

TABLE 21
Beer analysis

| | Hopst. | Hopst. | HOP | HOP | R5R + | R5R + |
|---|---|---|---|---|---|---|
| Parameter | EtOH | CO₂ | RE | R5R | Xn | 8PN |
| Original-wort [%] | 11.31 | 11.33 | 11.39 | 11.35 | 11.34 | 11.31 |
| Alcohol [% by volume] | 4.36 | 4.34 | 4.32 | 4.42 | 4.42 | 4.42 |
| Fermentation level [%] | 72.9 | 71.9 | 71.1 | 73.1 | 73.1 | 73.4 |
| Bitter units [BU] | 34 | 35 | 36 | 44 | 42 | 42 |
| Co-humulone [ppm] | 0.58 | 0.63 | n.n. | 0.54 | 0.42 | 0.46 |
| n-/ad-humulone [ppm] | 0.79 | 0.61 | 0.17 | 0.34 | 0.28 | 0.30 |
| Σ α-acids [ppm] | 1.37 | 1.24 | 0.17 | 0.88 | 0.70 | 0.76 |
| Co-Isohumulone [ppm] | 2.93 | 2.89 | 2.72 | 3.37 | 3.03 | 3.13 |
| n-Isohumulone [ppm] | 4.94 | 4.82 | 3.90 | 4.90 | 3.93 | 4.49 |
| Ad-Isohumulone [ppm] | 11.79 | 11.26 | 11.02 | 12.99 | 10.79 | 12.19 |
| Σ iso-α-acids [ppm] | 19.66 | 18.97 | 17.64 | 21.26 | 17.75 | 19.81 |
| Xanthohumol [ppm] | 0.3 | 0.5 | 0.5 | 0.3 | 5.7 | 0.3 |
| 8-Prenylnaringenin [ppm] | n.n. | n.n. | n.n. | n.n. | n.n. | 8.0 |
| pH | 4.47 | 4.49 | 4.52 | 4.51 | 4.49 | 4.49 |
| Colour [EBC] | 5.5 | 5.4 | 4.9 | 5.5 | 6.2 | 5.0 |
| Total nitrogen [mg/l] | 663 | 668 | 676 | 664 | 679 | 660 |
| Coagul. nitrogen [mg/l] | 18 | 20 | 21 | 19 | 20 | 20 |
| MgSO4-nitrogen [mg/l] | 156 | 145 | 141 | 144 | 142 | 140 |
| Polyphenols [mg/l] | 146 | 129 | 97 | 120 | 118 | 95 |
| Antho-cyanogens [mg/l] | 34 | 33 | 27 | 31 | 30 | 27 |

The original wort contents correlate as expected with that of the flavours. Corresponding to a fermentation level of 71-73% the alcohol content lies at 4.3-4.4% by volume. On the way from the wort to the beer conventionally ⅓ of the bitter units are lost by fermentation and further 7-8 bitter units after filtration. This is confirmed by the bitter values measured. While the α-acid contents decrease strongly against the flavour, the content of iso-α-acids changes only slightly. In the brew doted with xanthohumol a content of 5.7 mg/l have been measured. Less of a blind content of the original brew of 0.3 mg/l a high recovery of 96% results. The brew doted with 8-prenylnaringenin also showed a recovery of nearly 100%. The pH and the colour lie in the normal range of a bottom fermented fullbeer, wherein the last named correlated well with the content of polyphenols as with the flavours. The contents for the total nitrogen and the nitrogen fractions lie also in the normal range of a bottom fermented fullbeer. In the polyphenols the lower content in the flavour with HOP RE is also mirrored in the beer. Both the total polyphenols and the antho-cyanogens lie for all beers in the normal range.

Sensory Analysis of Beers with the Inventive Hops-Extract

The sensory analysis was carried out according to the DLG-test-scheme for beer. Features according to type and occurrence are assessed in the single sample-test according to a defined point-scheme (1-5). Aroma, pureness of the taste, being full-bodied (full-bodiment, respectively), the rezenz (recence, respectively) and the quality and intensity of the bittera (bitter, respectively) belong to the occurrences. The results are summarised in the following Table 22.

TABLE 22
Sensory analysis according to DLG-test-scheme

| | Hopst. | Hopst. | HOP | HOP | R5R + | R5R + |
|---|---|---|---|---|---|---|
| Test feature | EtOH | CO2 | RE | R5R | Xn | 8PN |
| Aroma | 4.6 | 4.0 | 4.8 | 4.8 | 4.4 | 4.4 |
| Purity of taste | 4.8 | 4.4 | 4.8 | 4.6 | 4.8 | 4.4 |
| Full-bodiment | 4.8 | 4.2 | 4.6 | 4.8 | 5.0 | 4.6 |
| Rezenz | 5.0 | 4.8 | 5.0 | 5.0 | 4.6 | 4.8 |
| Quality of the bitter | 4.0 | 4.6 | 4.6 | 4.4 | 4.2 | 4.2 |
| Intensity of the | 4.0 | 3.8 | 3.8 | 3.8 | 3.8 | 4.0 |
| bitter | | | | | | |

The beers HOP RE and HOP R5R are classified as “pure” regarding the aroma, the expectation to the aroma is fully met. Even the aroma of the Hopst. CO₂, assessed with the lowest value can be referred to as “still pure”. The discrepancies are thus little and result therefrom, that two of the testers have sensed the aroma of diacetyl in this beer what equals an aroma defect.

The beers Hopst. EtOH, HOP RE and R5R+Xn are assessed regarding to the taste as “pure”, the expectations are here fully met. With the other beers more testers in average have stated a slight discrepancy of the expected taste, but even with the lowest values one can speak about a largely pure taste.

All testers assessed the full-bodiment of R5R+Xn as sort typical. Even Hopst. CO₂ assessed with the lowest value is still assessed as “typical”, wherein the discrepancies even with this beer are thus low.

The expectation to the rezenz is fully met according to the opinion of all testers with the beers Hopst. EtOH, HOP RE and HOP R5R. These beers are assessed throughout as “pleasantly REZENT”. The discrepancies with the other beers are also very low.

The quality of the bitter can be referred as “very fine” with the beers Hopst. CO₂ and HOP RE. Even with the beer Hopst. EtOH assessed with the lowest grade the quality of the bitter in total is also still assessed as “fine”. The intensity of the bitter is in the average assessed as “bitter” the discrepancy of the expected intensity is low. This assessment with a Pils rather corresponds to a medium bitter. Stronger hoped Pils-beers are usually assessed with 5. The analytically measured, essentially higher bitter units with HOP R5R and the beers produced from this beer with addition of xanthohumol and 8-prenylnaringenin have regarding the bitter apparently no influence on the sensory aroma quality.

Altogether, the different beers result in a comparable and moreover good sensory result. The similarity is obvious, since fresh beer is concerned, in which except of the hops addition the additives and the whole brewing process is comparable.

1. Elution method for classified extraction and separation of vegetal material by multi elution processes, said method comprising:
crushing of vegetal basic material comprising the vegetal material,
filling an elution vessel with the crushed vegetal basic material, wherein the elution vessel has at least one inlet and at least one outlet, wherein for said crushed material solely one or more retention devices are arranged upstream said at least one outlet,
performing a first continuous elution process with a first solvent or solvent mixture,
performing a second continuous elution process with a second solvent or solvent mixture, wherein said second solvent or solvent mixture is different from said first solvent or solvent mixture,
optionally performing further continuous elution processes each with a further solvent or solvent mixture, wherein each further solvent or solvent mixture is different from each solvent or solvent mixture used before,
wherein said elution is performed by using the vegetal innate cellulose of the vegetal basic material as solid/stationary phase and wherein said elution processes are performed under normal conditions.

2. Method according to claim 1, wherein said crushing of vegetal basic material comprising the vegetal material is performed in pieces of at most 1 cm³ volume, preferably at most 10 mm³ volume, preferably at most 1 mm³ volume.

3. Method according to any of the preceding claims, wherein said basic material is mixed in crushed form with disaggregation materials, said disaggregation materials are preferably selected from the group consisting of sand, diatomaceous earth, cellulose.

4. Method according to any of the preceding claims, wherein in flow direction below a layer comprising said basic material in crushed form, said elution vessel is free from a layer of added material having separation properties.

5. Method according to any of the preceding claims, wherein said basic material is in dry form.

6. Method according to any of the preceding claims, wherein said continuous elution processes are performed with solvents or solvent mixtures of decreasing polarity.

7. Elution method for classified extraction and separation of hops material by multi elution processes, said method comprising:
crushing said hops material,
filling an elution vessel with said crushed hops material,
performing a first continuous elution process with a first solvent or solvent mixture,
performing a second continuous elution process with a second solvent or solvent mixture, wherein said second solvent or solvent mixture is different from said first solvent or solvent mixture,
optionally performing further continuous elution processes each with a further solvent or solvent mixture, wherein each further solvent or solvent mixture is different from each solvent or solvent mixture used before,
wherein said elution is performed by using the vegetal innate cellulose of the hops material as solid/stationary phase and wherein said elution processes are performed under normal conditions.

8. Method according to claim 7, wherein said hops material is selected from the group consisting of hops and hops processing products, wherein said hops processing products comprise preferably hops pellets, hops eluates and residue material of hops elution.

9. Method according to any of the claims 7 to 8, wherein said crushing of vegetal basic material comprising the vegetal material is performed in pieces of at most 1 cm³ volume, preferably at most 10 mm³ volume, preferably at most 1 mm³ volume.

10. Method according to any of the claims 7 to 9, wherein said basic material is mixed in crushed form with disaggregation materials, said disaggregation materials are preferably selected from the group consisting of sand, diatomaceous earth, cellulose.

11. Method according to any of the claims 7 to 10, wherein an elution is performed with at least one solvent or solvent mixture, which is selected from the group consisting of water, a mixture consisting of water and ethanol, a mixture comprising at least 70% by weight water and/or ethanol, and ethanol.

12. Method according to any of the claims 7 to 11, wherein said multistage elution process comprises at least two, preferably at least three, more preferably at least four of the following step elutions, A) elution with water, B) elution with an ethanol/water mixture having 25 to 35% by volume ethanol, C) elution with an ethanol/water mixture having 45 to 55% by volume ethanol, D) elution with an ethanol/water mixture having 75 to 85% by volume ethanol, E) elution with an ethanol/water mixture having 90 to 96% by volume ethanol.

13. Method according to any of the claims 7 to 12, wherein in an elution step an eluate is obtained comprising 6-prenylnaringenin and/or 8-prenylnaringenin.

14. Method according to any of the claims 7 to 12, wherein in an elution step an eluate is obtained comprising water soluble hops materials, particularly tanning agents.

15. Method according to any of the claims 7 to 12, wherein a hops eluate is obtained which is enriched or depleted one or more hops materials.

16. Method according to any of the claims 7 to 15, wherein a substance or substance mixture is obtained, said substance or substance mixture is selected from the group consisting of xanthohumol, hops eluate depleted xanthohumol, hops eluate enriched xanthohumol, 6-prenylnaringenin, hops eluate depleted 6-prenylnaringenin, hops eluate enriched 6-prenyl-naringenin, 8-prenylnaringenin, hops eluate depleted 8-prenylnaringenin, hops eluate enriched 8-prenylnaringenin, adlupulone, hops eluate depleted adlupulone, hops eluate enriched adlupulone, colupulone, hops eluate depleted colupulone, hops eluate enriched colupulone, lupulone, hops eluate depleted lupulone, hops eluate enriched lupulone, humulone, hops eluate depleted humulone, hops eluate enriched humulone, adhumulone, hops eluate depleted adhumulone, hops eluate enriched adhumulone, cohumulone, hops eluate depleted cohumulone, hops eluate enriched cohumulone, α-bitter acids, hops eluate depleted α-bitter acids, hops eluate enriched α-bitter acids, β-bitter acids, hops eluate depleted β-bitter acids, hops eluate enriched β-bitter acids, mixture of α-bitter acids enriched humulone, mixture of β-bitter acids enriched lupulone or mixtures thereof.

17. Method according to any of the claims 7 to 16, wherein said basic material is in dry form.

18. Method according to any of the claims 7 to 17, wherein said continuous elution processes are performed with solvents or solvent mixtures of decreasing polarity.

19. Hops eluate obtained by a method according to any of the preceding claims.

20. Beer obtainable by a method in which a hops eluate according to claim 19 is used.
